(19) United States
(12) Patent Application Publication
(10) Pub. No.: US 2024/0051134 A1
(43) Pub. Date: Feb. 15, 2024

(54) CONTROLLER, ROBOT SYSTEM AND LEARNING DEVICE

(71) Applicant: KAWASAKI JUKOGYO KABUSHIKI KAISHA, Hyogo (JP)

(72) Inventors: Hitoshi HASUNUMA, Hyogo (JP); Masayuki KAMON, Hyogo (JP); Takeshi YAMAMOTO, Hyogo (JP)

(73) Assignee: KAWASAKI JUKOGYO KABUSHIKI KAISHA, Hyogo (JP)

(21) Appl. No.: 18/267,309

(22) PCT Filed: Dec. 16, 2021
(86) PCT No.: PCT/JP2021/046542

§ 371 Date: Jun. 14, 2023

(30) Foreign Application Priority Data
Dec. 18, 2020 (JP) 2020-210012

(51) Int. Cl. B25J 9/16

(52) U.S. Cl. CPC B25J 9/1664; B25J 9/163; B25J 9/1653; B25J 9/1697

(57) ABSTRACT

A controller that performs a control in which a robot autonomously performs a given work includes a first processor. The first processor performs processing including acquiring state information including a state of a workpiece that is a work target while performing the given work, determining candidates of a work position of the workpiece based on the state information, transmitting a selection request for requesting a selection of the work position from the candidates of the work position to an operation terminal, the operation terminal being connected data-communicably with the first processor via a communication network, and when information on a selected position that is the selected work position is received from the operation terminal, causing the robot to operate autonomously according to the selected position.

### CROSS-REFERENCE TO RELATED APPLICATION

This application claims the priority and its benefit to Japanese Patent Application No. 2020-210012 filed on Dec. 18, 2020 with the Japan Patent Office, the entire contents of which are incorporated herein as a part of this application by reference.

### TECHNICAL FIELD

The present disclosure relates to a controller, a robot system, and a learning device.

### BACKGROUND ART

Conventionally, there is a technique for causing a robot to perform a given work by using a control in which a manual control and an autonomous control are combined. For example, JP1987-199376A discloses a remote manipulation device which uses a master and a slave. This device creates a procedure plan in which a manual operation part and an autonomous operation part are combined, based on data indicative of a skill level of an operator and a work target, and controls operation of the slave according to the procedure plan.

### DESCRIPTION OF THE DISCLOSURE

For example, operation of the slave which requires the operator's judgment among a series of works may correspond to the manual operation part disclosed in JP1987-199376A. Operation skill is required for the operator for the manual operation part. In recent years, a reduction in the number of expert operators for robots is concerned, because of aging of the operators and a shortage of successors.

One purpose of the present disclosure is to provide a controller, a robot system, and a learning device, which automate manipulation of operation of a robot which requires a judgment by an operator to enable diversification of available operators.

A controller according to one aspect of the present disclosure is a controller which performs a control in which a robot autonomously performs a given work. The controller includes a first processor. The first processor performs processing including acquiring state information including a state of a workpiece which is a work target while performing the given work, determining candidates of a work position of the workpiece based on the state information, transmitting a selection request for requesting a selection of the work position from the candidates of the work position to an operation terminal, the operation terminal being connected data-communicably with the first processor via a communication network, and when information on a selected position which is the selected work position is received from the operation terminal, causing the robot to operate autonomously according to the selected position.

### BRIEF DESCRIPTION OF DRAWINGS

FIG. 1 is a schematic view illustrating one example of a configuration of a robot system according to one embodiment.

FIG. 2 is a view illustrating one example of a configuration of a robot area according to one embodiment.

FIG. 3 is a block diagram illustrating one example of a hardware configuration of a controller according to one embodiment.

FIG. 4 is a block diagram illustrating one example of a functional configuration of the controller according to one embodiment.

FIG. 5 is a view illustrating one example of workpiece work information included in first attribute information according to one embodiment.

FIG. 6 is a view illustrating one example of the workpiece work information included in the first attribute information according to one embodiment.

FIG. 7 is a view illustrating one example of peripheral environment work information included in second attribute information according to one embodiment.

FIG. 8 is a view illustrating one example of candidates of a gripping position to be presented which are determined for a workpiece to be gripped.

FIG. 9 is a view illustrating one example of candidates of a locating position to be presented which are determined for a conveyance vehicle which is a transfer destination of the workpiece.

FIG. 10 is a view illustrating one example of indication of a scheduled operation of a robot according to one embodiment.

FIG. 11A is a flowchart illustrating one example of operation of the robot system according to one embodiment.

FIG. 11B is a flowchart illustrating one example of the operation of the robot system according to one embodiment.

FIG. 11C is a flowchart illustrating one example of the operation of the robot system according to one embodiment.

FIG. 12 is a block diagram illustrating one example of a functional configuration of a controller and a learning device according to a modification.

### MODES FOR CARRYING OUT THE DISCLOSURE

Hereinafter, illustrative embodiments of the present disclosure will be described with reference to the drawings. Each embodiment which will be described below illustrates a comprehensive or concrete example. Among components in the following embodiments, components which are not described in the independent claim(s) indicating the top concept are described as arbitrary components. Each of the figures in the accompanying drawings is a schematic figure, and is not necessarily illustrated exactly. In each drawing, the same reference characters are assigned to substantially the same components, and redundant explanation may be omitted or simplified. In this specification and the appended claims, a “device” may not only mean a sole device, but may also mean a system comprised of devices.

### [Configuration of Robot System]

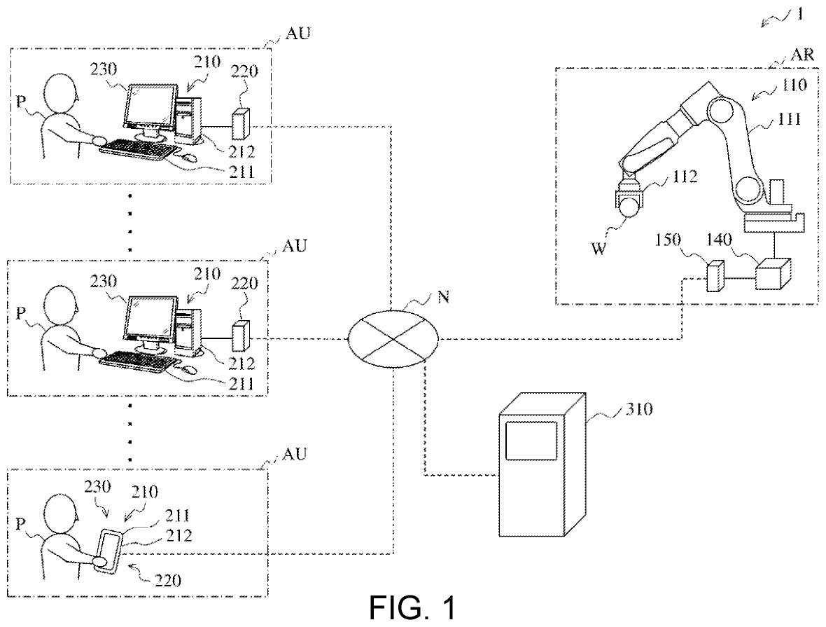

A configuration of a robot system 1 according to an illustrative embodiment is described. FIG. 1 is a schematic view illustrating one example of the configuration of the robot system 1 according to one embodiment. As illustrated in FIG. 1, the robot system 1 is a system which enables a user P who is an operator located at a remote location from a robot 110 to manipulate the robot 110 in a remote access environment. The robot system 1 includes one or more components disposed in a robot area AR, and one or more components disposed in a user area AU. Although not limited, in this embodiment, one robot area AR and a plurality of user areas AU exist as targets of the robot system 1.

The robot area AR is an area where one or more robots 110 are disposed. Although not limited, in this embodiment, the robot 110 is an industrial robot which performs a work. The robot 110 may be a service robot, construction machinery, a tunnel boring machine, a crane, a cargo conveyance vehicle, a humanoid, etc., instead of the industrial robot. The service robot is a robot used in various service industries, such as nursing, medical science, cleaning, guard, guidance, rescue, cooking, and goods offer. In the robot area AR, components which form a peripheral environment for the robot 110 to perform the work are also disposed.

The user area AU is an area where the user P who manipulates the robot 110 stays. Although not limited, in this embodiment, the user area AU is disposed at a location distant from the robot area AR, and in this robot system 1, many users P in many user areas AU can manipulate the robot 110 in the robot area AR. For example, many user areas AU may exist at various locations in a factory site including the robot area AR, various locations in a facility of a company which manages the factory, various locations in Japan, or various locations in the world.

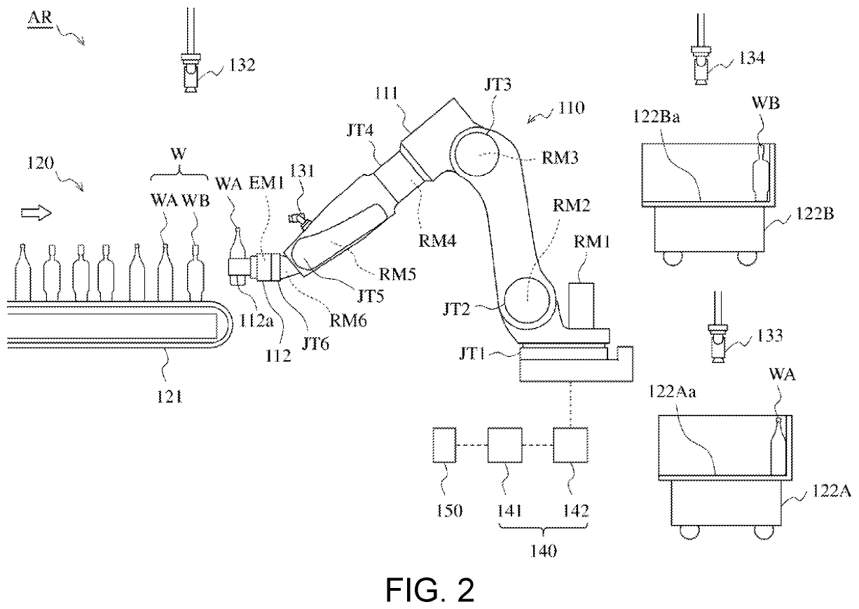

FIG. 2 is a view illustrating one example of a configuration of the robot area AR according to one embodiment. As illustrated in FIGS. 1 and 2, in the robot area AR, the robot system 1 includes one or more robots 110, peripheral equipment 120 of the robot 110, imagers 131-134, a controller 140, and a robot communicator 150. The controller 140 is connected communicably with the robot 110, the peripheral equipment 120, the imagers 131-134, and the robot communicator 150 in a wired fashion, a wireless fashion, or a combination thereof. Any kind of wired and wireless communications may be used. The robot communicator 150 is connected with a communication network N so that data communications are possible.

As illustrated in FIG. 1, in each user area AU, the robot system 1 includes an operation terminal 210, a user communicator 220, and a presenter 230. The user communicator 220 is connected communicably with the operation terminal 210 and the presenter 230 in a wired fashion, a wireless fashion, or a combination thereof. Any kind of wired and wireless communications may be used. The user communicator 220 is connected with the communication network N so that data communications are possible. For example, when a plurality of users P exist in one user area AU, one or more operation terminals 210, one or more presenters 230, and one or more user communicators 220 may be disposed in this user area AU.

Further, the robot system 1 includes a server 310 connected with the communication network N so that data communications are possible. The server 310 manages communication through the communication network N. The server 310 includes a computer. The server 310 manages authentication, connection, disconnection, etc. in the communications between the robot communicator 150 and the user communicator 220. For example, the server 310 stores identification information, security information, etc. on the robot communicator 150 and the user communicator 220 which are registered to the robot system 1, and authenticates qualification of each device for connecting with the robot system 1 based on the information. The server 310 may manage communications of data between the robot communicator 150 and the user communicator 220, and this data may go through the server 310. The server 310 may be configured to convert data transmitted from a transmission source into a data type which is compatible with a transmission destination. The server 310 may be configured to store and accumulate information, commands, data, etc. which are communicated between the operation terminal 210 and the controller 140 during operation of the robot 110. The server 310 is one example of a mediator.

The communication network N is not limited in particular, and, for example, it may include a local area network (LAN), a wide area network (WAN), the Internet, or a combination of two or more thereof. The communication network N may be configured to use short-distance wireless communications, such as Bluetooth® and ZigBee®, a dedicated or private line for network, a dedicated or private line for a communication enterprise, a public switched telephone network (PSTN), a mobile communications network, the Internet network, satellite communications, or a combination of two or more thereof. The mobile communications network may be one which uses a fourth-generation mobile communications system, a fifth-generation mobile communications system, etc. The communication network N may include one or more networks. In this embodiment, the communication network N is the Internet.

### [Components of Robot Area]

One example of the components of the robot area AR is described. As illustrated in FIGS. 1 and 2, in this embodiment, the robot 110 includes a robotic arm 111, and an end effector 112 which is attached to a tip end of the robotic arm 111. The robotic arm 111 has a plurality of joints so that it is operable in multiple degrees of freedom. The robotic arm 111 can move the end effector 112 to various locations and into various postures. The end effector 112 can apply an action to a workpiece W which is an object to be processed. Although the action of the end effector 112 is not limited in particular, it is an action of gripping the workpiece W in this embodiment.

Although not limited, in this embodiment, the robotic arm 111 includes six joints JT1-JT6, and servo motors RM1-RM6 as drives which drive the joints JT1-JT6, respectively. The number of joints of the robotic arm 111 is not limited to six, but may be any number, such as five or less, or seven or more. The end effector 112 includes a gripper 112a which is capable of performing gripping operation, and a servo motor EM1 as a drive which drives the gripper 112a. For example, the gripper 112a may include two or more fingered members which carry out the gripping operation and gripping releasing operation by the drive of the servo motor EM1. The drive of the end effector 112 does not require the servo motor EM1, but may have a configuration according to the configuration of the end effector 112. For example, when the end effector 112 has a configuration which sucks the workpiece W with negative pressure, the end effector 112 is connected with a negative pressure or vacuum generator as its drive.

The peripheral equipment 120 is disposed around the robot 110. For example, the peripheral equipment 120 may be operated collaboratively with the operation of the robot 110. The operation of the peripheral equipment 120 may be operation which gives the action to the workpiece W, or may be operation which does not give the action. Although not limited, in this embodiment, the peripheral equipment 120 includes a conveyor belt 121 which is capable of conveying the workpiece W, unmanned conveyance vehicles (hereinafter, simply referred to as “the conveyance vehicles”) 122A and 122B which are capable of autonomously conveying the workpiece W. For example, the unmanned conveyance vehicle may be an AGV (Automatic Guided Vehicle). The peripheral equipment 120 is not essential. Below, as for “the conveyor belt 121” and “the conveyance vehicles 122A and 122B,” each name may be used when they are expressed individually, and the name “peripheral equipment 120” may be used when they are expressed collectively.

The imagers 131-134 each include a camera which captures a digital image and configured to send data of the image captured by the camera to the controller 140. The controller 140 may be configured to process the image data captured by the imagers 131-134 into data which is transmittable through a network, and to send the data to the operation terminal 210 or the presenters 230 in the user area AU, or to the both, through the communication network N. The camera may be a camera which is capable of capturing an image for detecting a three-dimensional position of a photographic subject with respect to the camera, such as a distance to the photographic subject. The three-dimensional position is a position in a three-dimensional space. For example, the camera may have a configuration of a stereoscopic camera, a monocular camera, a TOF camera (Time-of-Flight camera), a pattern light projection camera such as a striped projection, or a camera using a light-section method. In this embodiment, the stereoscopic camera is used.

The imager 131 is disposed near a tip end of the robotic arm 111, and is directed to the end effector 112. The imager 131 is capable of capturing the workpiece W which is a target to which the end effector 112 gives an action. The imager 131 may be disposed at any location in the robot 110, as long as it is capable of capturing the above-described workpiece W. The imager 132 is fixedly disposed within the robot area AR, and images the robot 110 and the conveyor belt 121, for example, from above. The imagers 133 and 134 are fixedly disposed within the robot area AR, and image the conveyance vehicles 122A and 122B, respectively, which stand by at a waiting position near the robot 110, for example, from above. The imagers 131-134 may include a universal stand which supports the camera and is capable of operating so that the orientation of the camera is changed freely. The operation of the imagers 131-134 (i.e., operations of the cameras and the universal stands) are controlled by the controller 140.

The controller 140 includes an information processor 141 and a robot controller 142. The robot controller 142 is configured to control operations of the robot 110 and the peripheral equipment 120. The information processor 141 is configured to process various information, command, data, etc. which are communicated between the robot communicator 150 and the user communicator 220. For example, the information processor 141 is configured to process the command, the information, the data, etc. which are received from the robot controller 142 and the imagers 131-134, and send them to the operation terminal 210, the presenter 230, or both of these. For example, the information processor 141 is configured to process the command, the information, the data, etc. which are received from the operation terminal 210, and send them to the robot controller 142.

The information processor 141 and the robot controller 142 include a computer. Although the configuration of the information processor 141 is not limited in particular, for example, the information processor 141 may be an electronic circuit board, an electronic control unit, a microcomputer, a personal computer, a workstation, a smart device such as a smartphone and a tablet, and other electronic apparatuses. The robot controller 142 may include an electric circuit for controlling electric power which is supplied to the robot 110 and the peripheral equipment 120.

The robot communicator 150 includes a communication interface which is connectable with the communication network N. The robot communicator 150 is connected with the controller 140 (in detail, the information processor 141), and the information processor 141 is connected with the communication network N so that data communications are possible. The robot communicator 150 may include a communication apparatus, such as a modem, an ONU (Optical Network Unit: a terminating set of an optical network), a router, and a mobile data communication apparatus, for example. The robot communicator 150 may include a computer having a calculation function etc. The robot communicator 150 may be included in the controller 140.

### [Components of User Area]

One example of the components of the user area AU is described. As illustrated in FIG. 1, the operation terminal 210 is configured to accept an input, such as the command, the information, the data, etc. by the user P, and output the accepted command, information, data, etc. to other devices. The operation terminal 210 includes an operation input device 211 which accepts the input by the user P, and a terminal computer 212. The terminal computer 212 is configured to process the command, the information, the data, etc. which are accepted via the operation input device 211 and output them to other devices, and accept an input of a command, information, data, etc. from another device and process the command, the information, the data, etc. Although not limited, in this embodiment, the operation terminal 210 converts the image data of the imagers 131-134 sent from the controller 140 into data which is displayable on the presenter 230, and outputs and displays it on the presenter 230. The operation terminal 210 may include the operation input device 211 and the terminal computer 212 as integral devices or as separate devices.

The configuration of the operation terminal 210 is not limited in particular, but, for example, the operation terminal 210 may be a computer such as a personal computer, a smart device such as a smartphone and a tablet, a personal information terminal, a game terminal, a known teaching device such as a teach pendant used for teaching a robot, a known operation device for a robot, other operation devices, other terminal devices, devices using these devices, devices obtained by improving these devices, etc. Although the operation terminal 210 may be a device for exclusive use devised for the robot system 1, it may also be a general-purpose device which is available in common markets. In this embodiment, a known general-purpose device is used as the operation terminal 210. This device may be configured to realize the function of the operation terminal 210 of the present disclosure by software for exclusive use being installed.

The configuration of the operation input device 211 is not limited in particular, but, for example, the operation input device 211 may include a device in which the input is performed through the operation of a button, a lever, a dial, a joystick, a mouse, a key, a touch panel, a motion capture, etc. by the user P. In this embodiment, the operation input device 211 includes a known general-purpose device as the above-described device.

In this embodiment, the operation terminal 210 is the personal computer, the smartphone, or the tablet. If the operation terminal 210 is the personal computer, it does not include the user communicator 220 and the presenter 230, but it may include one or more of these devices. If the operation terminal 210 is the smartphone or the tablet, it includes the user communicator 220 and the presenter 230.

The presenter 230 includes a display which indicates an image to the user P. The presenter 230 displays an image of the image data received from the controller 140 via the operation terminal 210. Examples of the above-described image data are the image data captured by the imagers 131-134, and the data of the screen relevant to the operation of the robot 110. The presenter 230 may include a speaker which outputs voice to the user P. The presenter 230 outputs voice of voice data received from the controller 140 via the operation terminal 210. The presenter 230 may be included in the operation terminal 210.

The user communicator 220 includes a communication interface which is connectable with the communication network N. The user communicator 220 is connected with the operation terminal 210, and the operation terminal 210 is connected with the communication network N so that data communications are possible. The user communicator 220 may include a communication apparatus, such as a modem, an ONU, a router, and a mobile data communication apparatus, for example. The user communicator 220 may include a computer having a calculation function etc. The user communicator 220 may be included in the operation terminal 210.

### [Hardware Configuration of Controller]

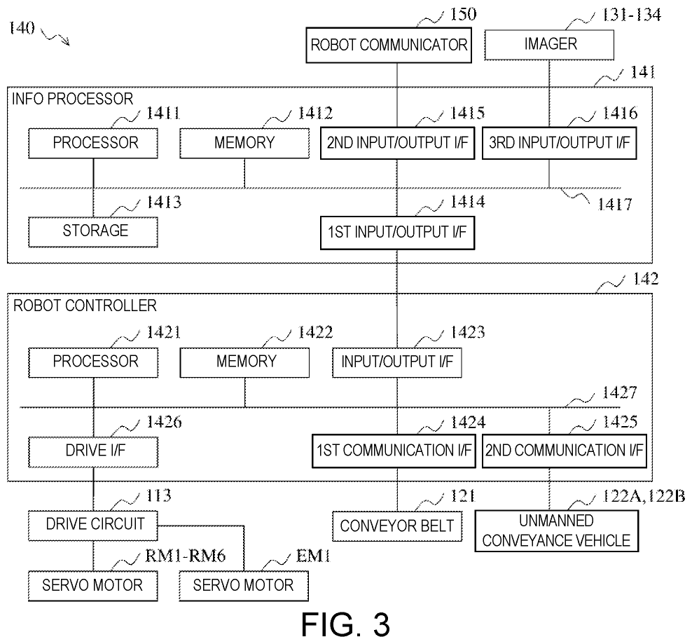

One example of a hardware configuration of the controller 140 according to one embodiment is described. FIG. 3 is a block diagram illustrating one example of the hardware configuration of the controller 140 according to one embodiment. As illustrated in FIG. 3, the information processor 141 includes a processor 1411, a memory 1412, a storage 1413, and input/output I/F s (Interfaces) 1414-1416, as components. Although the components of the information processor 141 are connected with each other through a bus 1417, they may be connected through any kind of wired communications or wireless communications. The robot controller 142 includes a processor 1421, a memory 1422, an input/output I/F 1423, communication I/Fs 1424 and 1425, and a drive I/F 1426, as components. The robot controller 142 may include a storage. Although the components of the robot controller 142 are connected with each other through a bus 1427, they may be connected through any kind of wired communications or wireless communications. Not all the components included in each of the information processor 141 and the robot controller 142 are essential.

For example, the information processor 141 includes circuitry, and this circuitry includes the processor 1411 and the memory 1412. The robot controller 142 includes circuitry, and this circuitry includes the processor 1421 and the memory 1422. These circuitry may include processing circuitry. The circuitry of the information processor 141, the processor 1411, and the memory 1412 may be provided separately from or integrally with the circuitry of the robot controller 142, the processor 1421, and the memory 1422, respectively. The circuitry communicates a command, information, data, etc. with other devices. The circuitry accepts an input of a signal from each of various apparatuses, and outputs a control signal to each of controlled targets. The processors 1411 and 1421 are examples of a first processor.

The memories 1412 and 1422 store a program which is executed by the processors 1411 and 1421, respectively, various data, etc. The memories 1412 and 1422 may include a storage, such as a semiconductor memory, which is a volatile memory and a nonvolatile memory, for example. Although not limited, in this embodiment, the memories 1412 and 1422 include a RAM (Random Access Memory) which is a volatile memory, and a ROM (Read-Only Memory) which is a nonvolatile memory. The memories 1412 and 1422 are examples of a first storage.

The storage 1413 stores various data. The storage 1413 may include a storage, such as a hard disk drive (HDD) and a solid state drive (SSD). The storage 1413 is one example of the first storage.

Each of the processors 1411 and 1421 forms a computer system together with the RAM and the ROM. The computer system of the information processor 141 may realize the function of the information processor 141 by the processor 1411 executing the program recorded on the ROM using the RAM as a work area. The computer system of the robot controller 142 may realize the function of the robot controller 142 by the processor 1421 executing the program recorded on the ROM using the RAM as a work area.

A part or all of the functions of the information processor 141 and the robot controller 142 may be realized by the above-described computer system, or may be realized by hardware circuitry for exclusive use, such as an electronic circuit or an integrated circuit, or may be realized by a combination of the above-described computer system and hardware circuitry. Each of the information processor 141 and the robot controller 142 may be configured to perform each processing by a centralized control with a sole device, or may be configured to perform each processing by a distributed control with a collaboration of devices.

Although not limited, for example, the processors 1411 and 1421 may include a CPU (Central Processing Unit), an MPU (Micro Processing Unit), a GPU (Graphics Processing Unit), a microprocessor, a processor core, a multiprocessor, an ASIC (Application-Specific Integrated Circuit), and an FPGA (Field Programmable Gate Array), and each processing may be realized by logical circuitry or dedicated circuitry formed in an IC (integrated circuit) chip, an LSI (Large Scale Integration), etc. Processings may be realized by one or more integrated circuits, or may be realized by a sole integrated circuit.

One of the information processor 141 and the robot controller 142 may be configured to include at least a part of a function of the other, or may be integrated with the other.

The first input/output I/F 1414 of the information processor 141 connects the information processor 141 with the robot controller 142, and enables an input/output of the information, the command, the data, etc. therebetween. The second input/output I/F 1415 connects the information processor 141 with the robot communicator 150, and enables an input/output of the information, the command, the data, etc. therebetween. The third input/output I/F 1416 connects the information processor 141 with the imagers 131-134, and enables an input/output of the information, the command, the data, etc. therebetween.

The input/output I/F 1423 of the robot controller 142 connects the robot controller 142 with first input/output I/F 1414 of the information processor 141, and enables an input/output of the information, the command, the data, etc. therebetween.

The first communication I/F 1424 connects the robot controller 142 with the conveyor belt 121 in a wired fashion, a wireless fashion, or a combination thereof, and enables communication of a signal etc. therebetween. The first communication I/F 1424 may include communication circuitry. For example, the robot controller 142 may be configured to receive a signal indicative of an operating state of the conveyor belt 121, such as an execution of operation, a stop of operation, and an operating speed, and control the operation of the robot 110 according to the operating state. The robot controller 142 may be configured to transmit to the conveyor belt 121 a signal which commands the operating state according to a processing situation of the workpiece W, such as a transfer situation, and control the operation of the conveyor belt 121.

The second communication I/F 1425 connects the robot controller 142 with the conveyance vehicles 122A and 122B in a wired fashion, a wireless fashion, or a combination thereof, and enables communication of a signal etc. therebetween. The second communication I/F 1425 may include communication circuitry. For example, the robot controller 142 may be configured to receive a signal indicative of an operating state of the conveyance vehicles 122A and 122B, such as positions with respect to the robot 110, and an arrival at and a leave from a standby position, and control the operation of the robot 110 according to the operating state. The robot controller 142 may be configured to transmit to the conveyance vehicles 122A and 122B a signal which commands an operating state according to a processing situation of the workpiece W, such as a loading situation, and control the operation of the conveyance vehicles 122A and 122B.

The drive I/F 1426 connects the robot controller 142 with a drive circuit 113 of the robot 110, and enables communication of a signal etc. therebetween. The drive circuit 113 is configured to control electric power which is supplied to the servo motors RM1-RM6 of the robotic arm 111 and the servo motor EM1 of the end effector 112 according to command values included in the signal received from the robot controller 142. For example, the drive circuit 113 can cause the servo motors RM1-RM6 and EM1 to drive cooperatively with each other.

The robot controller 142 may be configured to servo-control the servo motors RM1-RM6 and EM1. The robot controller 142 receives a detection value of a rotation sensor included in each of the servo motors RM1-RM6 and EM1, and command values of current from the drive circuit 113 to the servo motors RM1-RM6 and EM1, as feedback information. The robot controller 142 determines command values for driving the servo motors RM1-RM6 and EM1 by using the feedback information, and transmits them to the drive circuit 113.

The robot controller 142 may be configured so that axis controls of the servo motors may cooperate mutually. The robot controller 142 may be configured to control the servo motors RM1-RM6 as robot axis controls which is a part of axis controls, and control the servo motor EM1 as an external axis control which is a part of the axis controls.

Since a general-purpose device is available for the operation terminal 210 as a hardware configuration of the operation terminal 210, detailed explanation of the hardware configuration is omitted. The terminal computer 212 of the operation terminal 210 includes a processor and a memory similarly to the information processor 141 etc. The terminal computer 212 may include an input/output I/F for establishing each of a connection between the terminal computer 212 and the operation input device 211, a connection between the terminal computer 212 and the user communicator 220, and a connection between the terminal computer 212 and the presenter 230.

### [Functional Configuration of Controller]

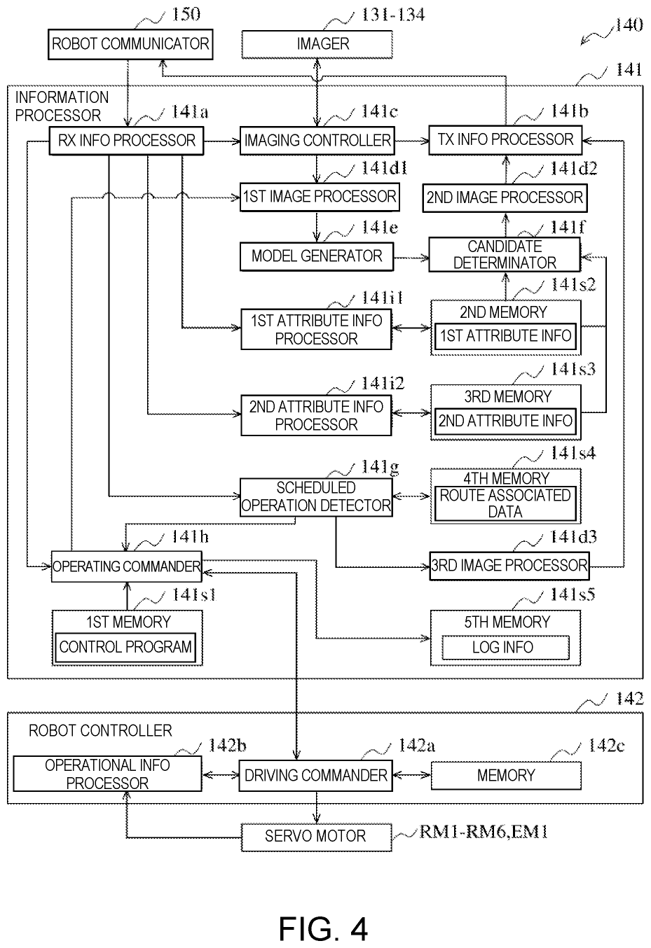

One example of a functional configuration of the controller 140 according to one embodiment is described with reference to FIG. 4. FIG. 4 is a block diagram illustrating one example of the functional configuration of the controller 140 according to one embodiment. The information processor 141 includes a reception information processor 141a and a transmission information processor 141b, an imaging controller 141c, image processors 141d1-141d3, a model generator 141e, a candidate determinator 141f, a scheduled operation detector 141g, an operating commander 141h, attribute information processors 141i1 and 141i2, and memories 141s1-141s5, as functional components. The functions of the functional components excluding the memories 141s1-141s5 are realized by the processor 1411 etc., and the functions of the memories 140s1-140s5 are realized by the memory 1412, the storage 1413, or a combination thereof. Not all the above-described functional components are essential.

The robot controller 142 includes a driving commander 142a, an operational information processor 142b, and a memory 142c, as functional components. The functions of the driving commander 142a and the operational information processor 142b are realized by the processor 1421 etc., and the function of the memory 142c is realized by the memory 1422 etc. Not all the above-described functional components are essential.

The memories 141s1-141s5 and 142c store various information, data, etc., and enable read-out of the stored information, data, etc.

The first memory 141s1 stores a control program for causing the robot 110 to autonomously perform a given work. For example, the control program may include a calculation program, a calculation formula, or a combination thereof for calculating an operating amount, an operating direction, an operating speed, an operating acceleration, etc. of each part of the robot 110 in the process for causing the robot 110 to perform a target operation. For example, as illustrated in FIG. 2, in this embodiment, the control program is a program for causing the robot 110 to autonomously perform the given work in which a workpiece W which is a beverage bottle conveyed on the conveyor belt 121 is transferred to the conveyance vehicle 122A or 122B. In the given work, the workpiece W includes two kinds of workpieces WA and WB, and the workpiece WA is transferred to the conveyance vehicle 122A, and the workpiece WB is transferred to the conveyance vehicle 122B.

The first memory 141s1 may store information on the robot 110. The information on the robot 110 may include types, identification information, characteristics, etc. of the robotic arm 111 and the end effector 112, for example. The characteristics of the robotic arm 111 may include a position, a model, a shape, a size, an operating direction, an operating range, etc. of the robotic arm 111, and a position, a type, an operating direction, an operating range, etc. of a joint. The characteristics of the end effector 112 may include a shape and a size of the end effector 112, and a position, an operating direction, an operating range, etc. of an operating part of the end effector 112. The characteristics of the robotic arm 111 and the end effector 112 may include elasticities, plasticities, toughnesses, brittlenesses, expansibilities, etc. thereof. The information on the robot 110 may include imaginary models, such as two-dimensional models and three-dimensional models, of the robotic arm 111 and the end effector 112.

The second memory 141s2 stores information on the workpiece W. For example, the second memory 141s2 stores first attribute information on the workpiece W. The first attribute information includes characteristics of the workpiece W, and workpiece work information which is information on the given work, which is set to the workpiece W. The characteristics of the workpiece W may include a type, a name, identification information, characteristics, etc. of the workpiece W, for example. The characteristics of the workpiece W may include a shape, a size, a weight, an elasticity, a plasticity, a toughness, a brittleness, an expansibility, a hollowness, a solidness, a center-of-gravity position, an opening position, etc. of the workpiece W. If the workpieces WA and WB are beverage bottles, the characteristics of the workpiece W may also include the existence, a kind, and an amount of contents, whether the spout is capped or uncapped, etc. The first attribute information may include an imaginary model of the workpiece W, such as a two-dimensional model and a three-dimensional model of the workpiece W, as the characteristics of the workpiece W.

The workpiece work information may include an order in which the workpieces W are processed, a speed and acceleration which can be given to the workpiece W, a position of the workpiece W at which the end effector 112 can give an action, a state of the workpiece W when the end effector 112 gives the action, etc. In this embodiment, the workpiece work information may include a position of the workpiece W at which the end effector 112 is able to grip (for example, a candidate of a gripping position). The workpiece work information may include a candidate of a posture of the workpiece W during the transfer by the robot 110. The workpiece work information may include a gripping force which can be applied to the workpiece W when it is gripped by the end effector 112 (for example, a candidate of the gripping force). The characteristics of the workpiece W and the workpiece work information may be set according to the workpiece W and the given work.

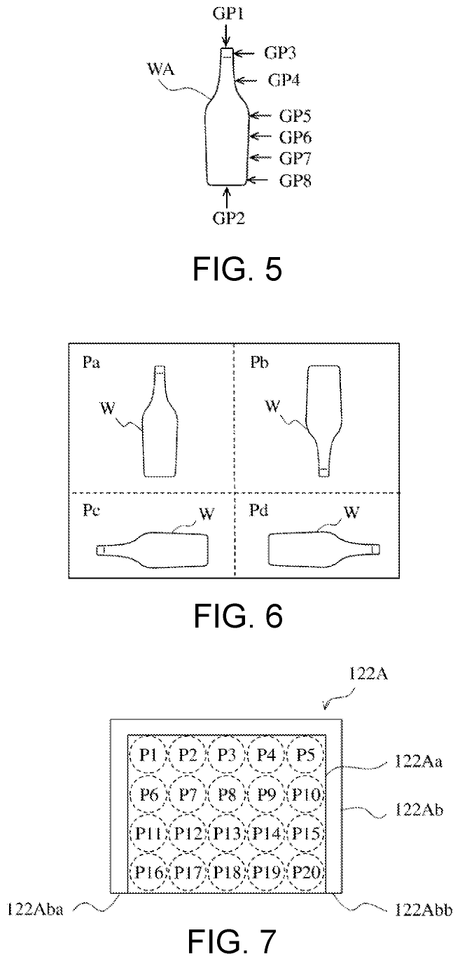

FIG. 5 is a view illustrating one example of the workpiece work information included in the first attribute information according to one embodiment. As illustrated in FIG. 5, for example, in the workpiece WA, a gripping position GP1 at a top end which is an opening end, a gripping position GP2 at a bottom end, and gripping positions GP3-GP8 of a side part between the top end and the bottom end are set beforehand as candidates of the gripping position. The workpiece work information on the workpiece WA includes information on the gripping positions GP1-GP8. The workpiece work information on the workpiece WB may include information on gripping positions similar to those of the workpiece work information on the workpiece WA.

FIG. 6 is a view illustrating another example of the workpiece work information included in the first attribute information according to one embodiment. As illustrated in FIG. 6, for example, postures Pa, Pb, Pc, and Pd of the workpiece WA are set beforehand as candidates of the posture of the workpiece WA during the transfer from the conveyor belt 121 to the conveyance vehicles 122A and 122B. The workpiece work information on the workpiece WA includes information on the postures Pa, Pb, Pc, and Pd. The workpiece work information on the workpiece WB may include information on postures similar to those of the workpiece work information on the workpiece WA.

The third memory 141s3 includes information on components within the robot area AR other than the robot 110. For example, the third memory 141s3 stores second attribute information and third attribute information. The second attribute information includes characteristics of a peripheral environment of the workpiece W, and peripheral environment work information which is information on the given work, which is set to this peripheral environment. The characteristics of the peripheral environment of the workpiece W includes characteristics of workpiece handling elements other than the robot 110, such as a device, equipment, and an apparatus, which handle the workpiece W, for example. In this embodiment, the characteristics of the peripheral environment of the workpiece W include characteristics of the peripheral equipment 120 (in detail, characteristics of the conveyor belt 121 and the conveyance vehicles 122A and 122B).

For example, the third attribute information includes characteristics of components within the robot area AR other than the peripheral environment included in the second attribute information. In this embodiment, the third attribute information includes the characteristics of the imagers 131-134. The characteristics may include identification information, characteristics, etc. of the imagers 131-134, for example. The characteristics of the imagers 131-134 may include positions, postures, shapes, sizes, installation methods, required separation distances from other components, etc. of the imagers 131-134.

The characteristics of the conveyor belt 121 may include a type, a name, identification information, characteristics, etc. of the conveyor belt 121, for example. The characteristics of the conveyor belt 121 may include a position, a posture, a shape, and a size of the conveyor belt 121, a position, a posture, a shape, and a size of a workspace of the robot 110 in the conveyor belt 121, the existence of an object which interrupts a space around the above-described workspace, and a position, a posture, a shape, a size, etc. of the object.

The characteristics of the conveyance vehicles 122A and 122B may include a type, a name, identification information, characteristics, etc. of the conveyance vehicles 122A and 122B, for example. The characteristics of the conveyance vehicles 122A and 122B may include standby positions, standby postures, shapes, and sizes of the conveyance vehicles 122A and 122B, characteristics of mounting parts 122Aa and 122Ba of the workpieces WA and WB in the conveyance vehicles 122A and 122B, etc. The standby positions and the standby postures are positions and orientations of the conveyance vehicles 122A and 122B when the workpieces WA and WB are processed by the robot 110. The characteristics of the mounting parts 122Aa and 122Ba may include positions, shapes, sizes, tilting amounts, elasticities, plasticities, toughnesses, brittlenesses, expansibilities, etc. of the surfaces of the mounting parts 122Aa and 122Ba. The shape of the surface may include a shape in the plan view, a concavo-convex shape in the vertical direction, etc. Further, the characteristics of the conveyance vehicles 122A and 122B may include the existence of objects which interrupt spaces around the mounting parts 122Aa and 122Ba, and positions, shapes, sizes, etc. of the objects.

The second attribute information may include imaginary models, such as two-dimensional models and three-dimensional models of the conveyor belt 121 and the conveyance vehicles 122A and 122B, as the characteristics of the conveyor belt 121 and the conveyance vehicles 122A and 122B. The third memory 141s3 may include, as information on components other than the conveyor belt 121 and the conveyance vehicles 122A and 122B within the robot area AR, imaginary models of these components.

The peripheral environment work information includes information on the given work for a workpiece handling element which handles the workpiece W other than the robot 110, for example. The peripheral environment work information may include a position, a state, a processing method, etc. of the workpiece W when the workpiece W is processed by the workpiece handling element. In this embodiment, the peripheral environment work information on the conveyance vehicles 122A and 122B may include candidates of locating positions, candidates of arrangement postures, candidates of arrangement orders, candidates of arrangement directions, candidates of arrangement methods, etc. of the workpieces WA and WB on the surfaces of the mounting parts 122Aa and 122Ba. For example, the arrangement directions may indicate the transferring directions of the workpieces WA and WB to the mounting parts 122Aa and 122Ba. The arrangement methods may indicate degrees of impacts given to the mounting parts 122Aa and 122Ba by the workpieces WA and WB, accelerations of the workpieces WA and WB, etc. when placing them.

FIG. 7 is a view illustrating one example of the peripheral environment work information included in the second attribute information according to one embodiment. FIG. 7 illustrates a plan view of the mounting part 122Aa of the conveyance vehicle 122A. The conveyance vehicle 122A includes a wall 122Ab which surrounds the circumference of the mounting part 122Aa and extends upwardly from the mounting part 122Aa. The wall 122Ab forms a U-shape in the plan view from above, and opens a part of the mounting part 122Aa to the side between open ends 122Aba and 122Abb. The wall 122Ab opens the mounting part 122Aa upwardly. On the surface of the mounting part 122Aa, locating positions P1-P20 for the bottom part of the workpiece WA are set beforehand as candidates of the locating position. The locating positions P1-P20 are arranged in 4-lines×5-rows.

The peripheral environment work information on the conveyance vehicle 122A includes the locating position P1-P20, the postures of the workpiece WA at the locating positions P1-P20, the arrangement directions of the workpiece WA to the locating positions P1-P20, and the arrangement methods of placing the workpiece WA at the locating positions P1-P20 with a low impact (i.e., a low acceleration). The peripheral environment work information on the conveyance vehicle 122B may include information similar to the peripheral environment work information on the conveyance vehicle 122A.

The fourth memory 141s4 stores route associated data. The route associated data includes information for determining a moving route of the end effector 112 when performing the given work. The route associated data includes information for determining the moving route of the end effector 112 when performing operation in a case where at least a part of the operation included in the given work is identified. For example, the route associated data may include a calculation formula of the moving route of the end effector 112, a program of the calculation, or a combination thereof.

The fifth memory 141s5 stores and accumulates log information on the robot 110. The fifth memory 141s5 stores information on results of operations of the robotic arm 111 and the end effector 112 of the robot 110 which performs the given work, including the results of operations, commands for the results, or both of these, as the log information. The log information stored may include information on all the results of operations of the robotic arm 111 and the end effector 112. The log information stored may include at least information on the results of operations in the workspace of the end effector 112 on the conveyor belt 121 and in the vicinity, and information on the results of operations in the conveyance vehicles 122A and 122B and in the vicinity.

The memory 142c stores information for the driving commander 142a to generate a driving command using the operating command received from the operating commander 141h.

The reception information processor 141a receives a command, information, data, etc. from the operation terminal 210 via the communication network N and the robot communicator 150, and sends them to the corresponding functional components in the information processor 141. The reception information processor 141a may have a function for converting the command, the information, the data, etc. which are received into data format which can be processed in the information processor 141.

The transmission information processor 141b transmits the command, the information, the data, etc. which are outputted from each functional component of the information processor 141 to the operation terminal 210 via the robot communicator 150 and the communication network N. The transmission information processor 141b may have a function for converting the command, the information, the data, etc. for the transmission destination into data format which enables the network communication.

The imaging controller 141c controls operations of the imagers 131-134, and outputs the image data captured by the imagers 131-134. For example, the imaging controller 141c controls the operations of the cameras and the universal stands of the imagers 131-134 according to the command received from the operation terminal 210. The imaging controller 141c receives the image data from the imagers 131-134, and outputs them to the first image processor 141d1, the transmission information processor 141b, etc. For example, the imaging controller 141c transmits to the operation terminal 210 the image data of the imagers 131-134 specified by the command from the operation terminal 210. The operation terminal 210 outputs and displays the image data to/on the presenter 230.

The first image processor 141d1 processes the image data captured by the imager 131, the imager 132, or both of these. The first image processor 141d1 performs image processing for extracting the workpiece W and the surrounding component(s) from the image indicated by the image data. Further, the first image processor 141d1 may detect a three-dimensional position of a photographic subject which is projected to pixels which display the workpiece W and the surrounding component(s).

For example, the first image processor 141d1 may extract an edge from each of two image data captured simultaneously by the imager 131 and 132 of the stereoscopic camera. Further, the first image processor 141d1 may compare the extracted edge with the shape of the workpiece W included in the first attribute information stored in the second memory 141s2 by using a pattern matching technique etc., and identify an edge of the workpiece W. The first image processor 141d1 may compare the extracted edge with the shape of the conveyor belt 121 and the shape of the object which interrupts the space around the workspace thereof included in the second attribute information stored in the third memory 141s3 by the pattern matching technique etc., and identify edges of the conveyor belt 121 and the above-described object, as the edges of the surrounding components.

Further, the first image processor 141d1 may process the pixels which display the workpiece W and the surrounding component(s) between the two image data by using a stereo matching technique etc., and detect a distance between the photographic subject which is projected to the pixels and the camera. Moreover, the first image processor 141d1 may detect a three-dimensional position of the photographic subject which is projected to the pixels in the three-dimensional space where the robot system 1 exists.

The model generator 141e generates the imaginary models of the workpiece W and the surrounding component(s) which are extracted from the image data by the first image processor 141d1. For example, based on the information on the workpiece W stored in the second memory 141s2, and the information on the surrounding component(s) stored in the third memory 141s3, the model generator 141e generates the imaginary models indicative of the workpiece W and the surrounding component(s) which are projected by the above-described image data. For example, the model generator 141e may generate three-dimensional CAD (Computer-Aided Design) models of the workpiece W and the surrounding component(s). The model generator 141e and the first image processor 141d1 can detect state information including the state of the workpiece W by generating the above-described imaginary models. The imaginary models indicative of the workpiece W and the surrounding component(s) are one example of state information on the workpiece W.

The state information may include various information indicative of the states of the workpiece W and the surrounding component(s), for example. For example, additionally or alternatively to the imaginary models of the workpiece W and the surrounding component(s), the state information may include positions, postures, move directions of the positions and the postures, moving speeds of the positions and the postures, etc. of the imaginary models of the workpiece W and the surrounding component(s). The state information may include various information indicative of a state of the peripheral environment of the workpiece W. For example, the state information may include an arrangement state of the workpiece W in the conveyance vehicle 122A or 122B as the transfer destination of the workpiece W.

The candidate determinator 141f determines candidates of the work position for the workpiece W based on the state information, and outputs them to the second image processor 141d2. The candidates of the work position for the workpiece W include candidates of the gripping position to be presented, of the workpiece W which is the gripping target of the robot 110, and candidates of the locating position to be presented, in the conveyance vehicle 122A or 122B which is the transfer destination of the workpiece W. Further, the candidate determinator 141f may search the fifth memory 141s5, and may output to the second image processor 141d2 information on the gripping position and the locating position determined in the past for a workpiece in a state similar to the above-described workpiece W.

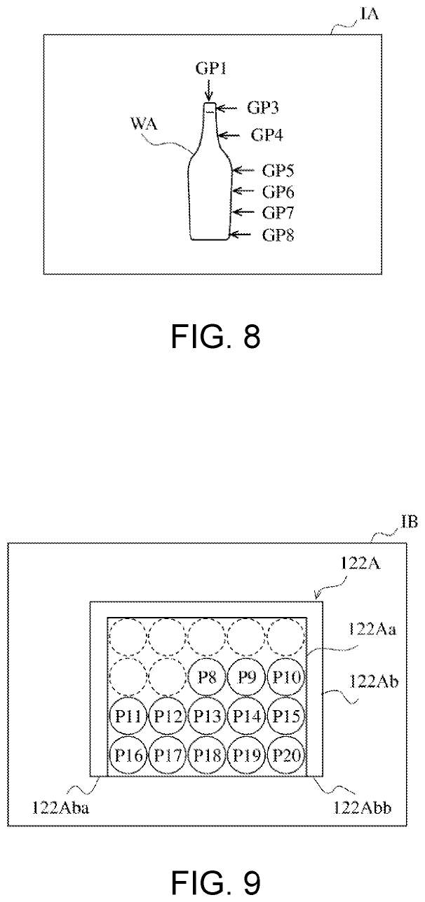

For example, the candidate determinator 141f determines, as the state information, candidate(s) of the gripping position to be presented to the user P out of the candidates of the gripping position of the workpiece W included in the first attribute information, by using the models of the workpiece W and the surrounding component(s) generated by the model generator 141e. For example, when the model of the workpiece WA is in an upright state like the posture Pa of FIG. 6, the candidate determinator 141f determines the gripping positions GP1 and GP3-GP8 which can be gripped as the candidate to be presented, as illustrated in FIG. 8. FIG. 8 is a view illustrating one example of candidates of the gripping position to be presented, which are determined for the workpiece WA to be gripped. For example, the candidate determinator 141f may determine the gripping positions GP3-GP8 as the candidates to be presented, when the workpiece WA lies. For example, when another workpiece is piled up on one workpiece WA which lies, the candidate determinator 141f may determine gripping position(s) which are grippable among the gripping positions GP1-GP8 as the candidate(s) to be presented.

Further, the candidate determinator 141f determines a candidate of the locating position to be presented to the user P out of the locating positions of the conveyance vehicle 122A or 122B which is the transfer destination included in the second attribute information. For example, the candidate determinator 141f may determine, as the candidate to be presented, a locating position where the workpiece W is placeable, based on the information on the locating positions of the workpieces W which have already been disposed, as the state information. The above-described information on the locating position may be stored in the third memory 141s3 or the fifth memory 141s5. For example, as illustrated in FIG. 9, the candidate determinator 141f determines the remaining locating positions P8-P20 which are obtained by excluding the locating positions of the workpieces WA which have already been disposed, as the candidates to be presented. FIG. 9 is a view illustrating one example of the candidates of the locating position to be presented which are determined in the conveyance vehicle 122A which is the transfer destination of the workpiece WA.

The second image processor 141d2 images the candidate determined by the candidate determinator 141f and transmits it to the operation terminal 210. This candidate may include the candidate of the gripping position in the workpiece W to be presented, and the candidate of the locating position in the conveyance vehicle 122A or 122B to be presented. The second image processor 141d2 may clearly express, in the image, the information on the gripping position and the locating position determined in the past for the workpiece in a state similar to the above-described workpiece W, together with the candidate of the gripping position to be presented and the candidate of the locating position to be presented. Therefore, the user of the operation terminal 210 can determine the gripping position and the locating position with reference to the past information indicative of the similar state.

For example, the second image processor 141d2 may generate data of an image IA as illustrated in FIG. 8, based on the information on the candidates of the gripping position of the workpiece WA to be presented, and the model of the workpiece WA generated by the model generator 141e. The image IA clearly expresses the gripping positions GP1 and GP3-GP8 which are the candidates to be presented, in the image of the model of the workpiece WA. The second image processor 141d2 transmits to the operation terminal 210 the data of the image IA, and a demand for selecting the gripping position. The second image processor 141d2 may transmit to the operation terminal 210 the information on the gripping positions GP1 and GP3-GP8, instead of the data of the image IA.

The second image processor 141d2 may synthesize the data of the image IA with the image data captured by the imager 131, the imager 132, or both of these. Therefore, the gripping positions GP1 and GP3-GP8 are clearly expressed in the image of the workpiece WA which is projected to the image captured by the imager 131, the imager 132, or both of these.

The user P of the operation terminal 210 selects one of the gripping positions GP1 and GP3-GP8 which the operation terminal 210 presents to the presenter 230, inputs the selected result into the operation terminal 210 as a selected work position, and causes the operation terminal 210 to transmit the selected work position to the information processor 141. The selected work position is one example of a selected position.

For example, the second image processor 141d2 may generate data of an image IB as illustrated in FIG. 9, based on the information on the candidate of the locating position in the conveyance vehicle 122A or 122B to be presented, and the information on the conveyance vehicle 122A or 122B included in the second attribute information. The image IB clearly expresses the locating positions P8-P20 which are candidates to be presented, in the image of the mounting part 122Aa or 122Ba. The second image processor 141d2 transmits to the operation terminal 210 the data of the image IB, and a demand for selecting the locating position. The second image processor 141d2 may transmit the information on the locating positions P8-P20 to the operation terminal 210, instead of the data of the image IB.

The second image processor 141d2 may synthesize the data of the image IB with the image data captured by the imager 133 or 134. Therefore, the locating positions P8-P20 are clearly expressed in the image of the mounting part 122Aa or 122Ba which is projected to the image captured by the imager 133 or 134.

The user P of the operation terminal 210 selects one of the locating positions P8-P20 which the operation terminal 210 presents to the presenter 230, inputs the selected result into the operation terminal 210 as a selected work position, and causes the operation terminal 210 to transmit the selected work position to the information processor 141.

The scheduled operation detector 141g receives from the operation terminal 210 information on the selected work position which is selected from the candidates of the work position for the workpiece W. The scheduled operation detector 141g detects a scheduled operation of the robot 110 according to the selected work position based on the information on the selected work position, and the route associated data stored in the fourth memory 141s4.

For example, the scheduled operation detector 141g determines the gripping position of the workpiece W included in the selected work position as a starting point, determines the locating position of the workpiece W included in the selected work position as an ending point, and calculates a moving route of the end effector 112 from the starting point to the ending point by using the calculation formula of the route associated data, the calculation program, or both of these. Further, the scheduled operation detector 141g calculates a posture of the end effector 112 at each position on the moving route of the end effector 112. The scheduled operation detector 141g detects the moving route and the posture of the end effector 112 on the moving route as the scheduled operation of the robot 110 according to the selected work position.

The scheduled operation detector 141g transmits the detected scheduled operation to the operation terminal 210 via the third image processor 141d3. The operation terminal 210 presents the received scheduled operation to the user P via the presenter 230. The operation terminal 210 can accept an input for approving the scheduled operation, an input for correcting the scheduled operation, an input for changing a selected gripping position and locating position, and an input for changing the first attribute information and the second attribute information.

When an approval of the scheduled operation is accepted, the operation terminal 210 transmits the approval result to the information processor 141. The scheduled operation detector 141g sends the approved scheduled operation to the operating commander 141h.

When a correction of the scheduled operation is accepted, the operation terminal 210 transmits the accepted contents of the correction to the information processor 141. The scheduled operation detector 141g corrects the scheduled operation so as to reflect the contents of the correction of the scheduled operation, and generates the corrected scheduled operation as a new scheduled operation. The scheduled operation detector 141g transmits the new scheduled operation to the operation terminal 210.

When a change in the gripping position, the locating position, or both of these is accepted, the operation terminal 210 transmits the accepted contents of the change to the information processor 141. The scheduled operation detector 141g generates a new scheduled operation according to the contents of the change in the gripping position, the locating position, or both of these. The scheduled operation detector 141g transmits the new scheduled operation to the operation terminal 210.

When the change in the first attribute information, the second attribute information, or both of these is accepted, the operation terminal 210 transmits the accepted contents of the change to the information processor 141. The first attribute information processor 141i1 and the second attribute information processor 141i2 change the first attribute information stored in the second memory 141s2, the second attribute information stored in the third memory 141s3, or both of these, according to the received contents of the change. The first attribute information processor 141i1 and the second attribute information processor 141i2 store the changed first attribute information and second attribute information in the second memory 141s2, the third memory 141s3, or both of these, as the new first attribute information and second attribute information. The scheduled operation detector 141g generates the new scheduled operation by using the new first attribute information and second attribute information, and transmits it to the operation terminal 210.

The scheduled operation detector 141g detects, based on the information on the components other than the robot 110 within the robot area AR stored in the third memory 141s3, the existence of an interference of the robot 110 with the above-described components in the process of the scheduled operation, and transmits the detection result to the operation terminal 210. For example, based on the third attribute information, if the moving route of the end effector 112 passes through an area within the separation distance from the imagers 131-134, the scheduled operation detector 141g may detect the occurrence of the interference. If the occurrence of the interference is detected, the scheduled operation detector 141g may re-calculate the moving route of the end effector 112 based on the separation distance for the interference object so that the interference is avoided.

The third image processor 141d3 images the scheduled operation generated by the scheduled operation detector 141g, and transmits it to the operation terminal 210. For example, the third image processor 141d3 may generate the image data which clearly expresses the moving route of the end effector 112 based on the information on the components other than the robot 110 within the robot area AR stored in the third memory 141s3, the information on the robot 110 stored in the first memory 141s1, and the scheduled operation detected by the scheduled operation detector 141g.

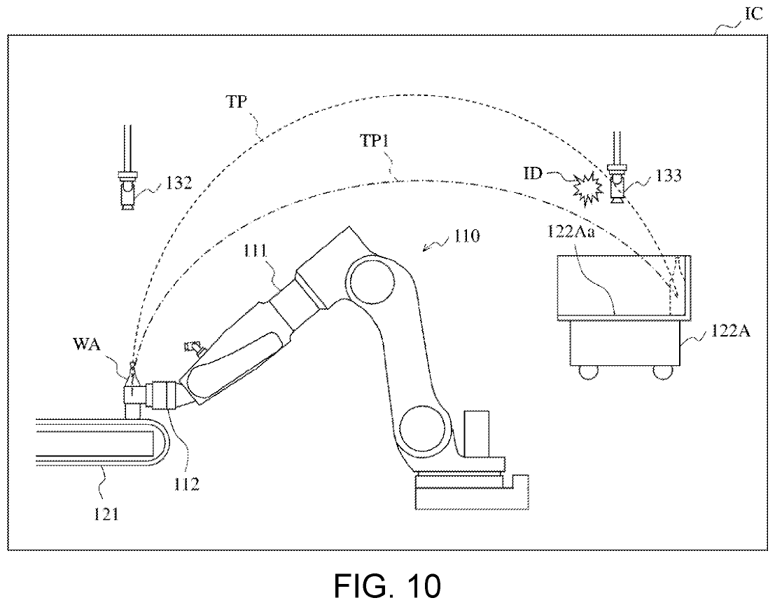

For example, the third image processor 141d3 may generate data of an image IC as illustrated in FIG. 10. The image IC indicates a moving route TP of the end effector 112 illustrated by a broken line, a model of the robotic arm 111, a model of the end effector 112, a model of the conveyor belt 121, a model of the conveyance vehicle 122A which is the transfer destination of the workpiece W, and models of the imagers 132 and 133 which are other components within the robot area AR. Since in the image IC the moving route TP interferes with the imager 133, an image ID indicative of the interference is displayed. When the scheduled operation is changed by the operation terminal 210 in order to avoid the interference, the scheduled operation detector 141g generates the new scheduled operation according to the contents of the change, and the third image processor 141d3 clearly expresses a moving route TP1 for the new scheduled operation which is illustrated by a one-dot chain line in the image IC. Therefore, the user P of the operation terminal 210 can judge the approval of the scheduled operation, while visually examining the moving route.

The first attribute information processor 14E1 changes the first attribute information stored in the second memory 141s2 according to the command received from the operation terminal 210, and stores the changed first attribute information in the second memory 141s2 as the new first attribute information. That is, the first attribute information processor 141i1 updates the first attribute information. The first attribute information processor 141i1 may transmit the first attribute information to the operation terminal 210. For example, the first attribute information processor 141i1 may transmit the first attribute information corresponding to the selected work position to the operation terminal 210. The first attribute information processor 141i1 may output the first attribute information to the second image processor 141d2 and the third image processor 141d3, and clearly express the first attribute information in the generated image.

The second attribute information processor 141i2 changes the second attribute information stored in the third memory 141s3 according to the command received from the operation terminal 210, and stores the changed second attribute information in the third memory 141s3 as the new second attribute information. That is, the second attribute information processor 141i2 updates the second attribute information. The second attribute information processor 141i2 may transmit the second attribute information to the operation terminal 210. For example, the second attribute information processor 141i2 may transmit the second attribute information corresponding to the selected work position to the operation terminal 210. The second attribute information processor 141i2 may output the second attribute information to the second image processor 141d2 and the third image processor 141d3, and clearly express the second attribute information in the generated image.

The operating commander 141h generates an operating command for causing the end effector 112 to move and operate according to the control program stored in the first memory 141s1. The operating commander 141h generates an operating command for causing the end effector 112 to move and operate according to the approved scheduled operation generated by the scheduled operation detector 141g. That is, the operating commander 141h generates the operating command according to the selected work position, the first attribute information, and the second attribute information. The operating commander 141h transmits the operating command to the robot controller 142. The operating command includes, among a position command and a force command for the end effector 112, at least the position command, and in this embodiment, it includes both the commands. Further, the operating command includes a command for the gripping force of the end effector 112 to the workpiece W. The operating commander 141h may store the operating command, the approved scheduled operation, the gripping position and the locating position which are included in the scheduled operation, the driving command which is acquired from the driving commander 142a, or a combination of two or more thereof, in the fifth memory 141s5 as the log information.

The position command may include commands for a target position in the three-dimensional space, a moving speed of the target position, a target posture, a moving speed of the target posture, etc. of the end effector 112. The force command may include commands for the magnitude, the direction, etc. of the force which the end effector 112 applies to the workpiece W, in the three-dimensional space. The force command may include an acceleration which the end effector 112 applies to the workpiece W.

The driving commander 142a generates a driving command for operating the robotic arm 111 and the end effector 112 based on the information stored in the memory 142c so that the end effector 112 moves and performs a gripping operation according to the operating command. The driving command includes command values of current of the servo motors RM1-RM6 of the robotic arm 111, and the servo motor EM1 of the end effector 112. The driving commander 142a generates the driving command based on feedback information received from the operational information processor 142b.

The operational information processor 142b acquires information on rotation amounts and current values from the servo motors RM1-RM6 and EM1, and outputs the information to the driving commander 142a as feedback information. The operational information processor 142b acquires the rotation amount of each servo motor from the rotation sensor included in the servo motor. The operational information processor 142b acquires the current value of each servo motor from the command value of the current of the drive circuit of the servo motor. If a current sensor is provided to each servo motor, the operational information processor 142b may acquire the current value from the current sensor.

### [Operation of Robot System]

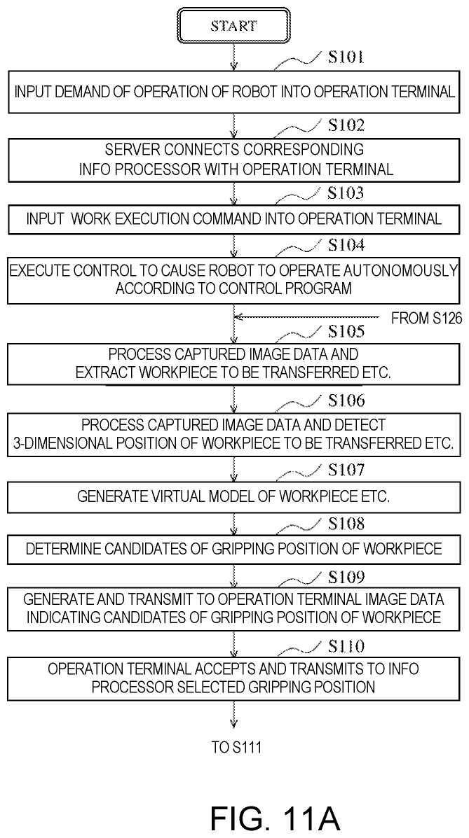

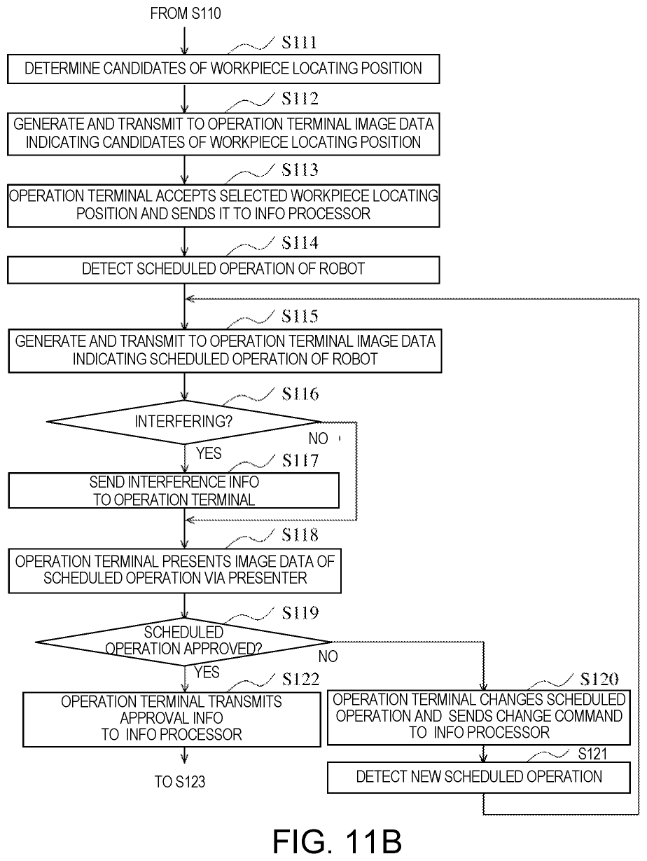

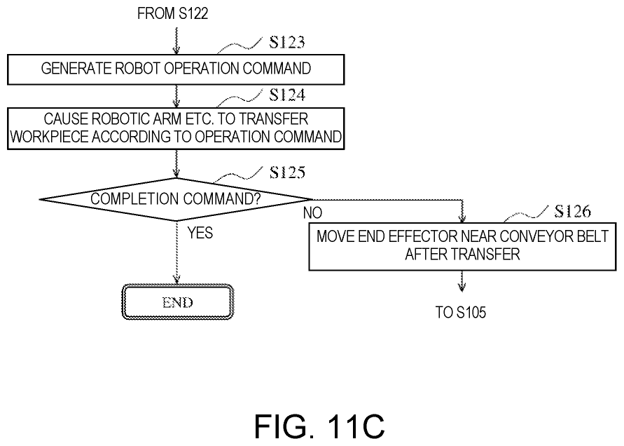

One example of operation of the robot system 1 according to one embodiment is described with reference to FIGS. 11A to 11C. FIGS. 11A to 11C illustrate a flowchart of one example of the operation of the robot system 1 according to one embodiment. First, the user P inputs into the operation terminal 210 a demand indicating that he/she takes charge of the operation of the robot which performs the transferring work of the workpiece, and the operation terminal 210 then transmits the demand to the server 310 (Step S101). The server 310 searches for the robot 110 which can perform the work, and connects the information processor 141 of the searched robot 110 with the above-described operation terminal 210 via the communication network N (Step S102).

When a notice of the completion of the connection is received from the server 310, the user P inputs an execution command for the transferring work into the operation terminal 210. The operation terminal 210 transmits this command to the information processor 141 (Step S103).

The information processor 141 starts a control for the transferring work to cause the robot 110 to operate autonomously according to the control program stored in the first memory 141s1 (Step S104).

When the end effector 112 of the robot 110 approaches the conveyor belt 121, the information processor 141 processes the image data captured by the imager 131, and extracts the workpiece W to be transferred and the component(s) around the workpiece W which are projected to the image data (Step S105). The information processor 141 may process the image data captured by the imager 132, and extract the workpiece W to be transferred etc.

The information processor 141 further processes the image data, and detects three-dimensional positions of the extracted workpiece W and surrounding component(s) (Step S106).

The information processor 141 generates the imaginary models of the workpiece W and the surrounding component(s) which are extracted at Step S105 (Step S107), and based on the above-described imaginary models and the first attribute information, it determines the candidates of the gripping position of the workpiece W (Step S108).

The information processor 141 generates image data indicative of the candidates of the gripping position of the workpiece W, and transmits it to the operation terminal 210 (Step S109). The information processor 141 also transmits the first attribute information to the operation terminal 210.

The operation terminal 210 displays the received image data and the first attribute information on the presenter 230. The user P can view the candidates of the gripping position of the workpiece W displayed on the presenter 230, and select the gripping position. When a command for specifying the selected gripping position which is one of the candidates of the gripping position of the workpiece W is received from the user P, the operation terminal 210 transmits the information on the selected gripping position to the information processor 141 (Step S110).

The information processor 141 determines the candidate of the locating position of the workpiece W in the conveyance vehicle 122A or 122B based on the second attribute information (Step S111).

The information processor 141 generates image data indicative of the candidate of the locating position of the workpiece W in the conveyance vehicle 122A or 122B, and transmits it to the operation terminal 210 (Step S112). The information processor 141 also transmits the second attribute information to the operation terminal 210.

The operation terminal 210 displays the received image data and the second attribute information on the presenter 230. The user P can view the candidate of the locating position of the workpiece W displayed on the presenter 230, and select the locating position. When a command for specifying the selected locating position which is one of the candidates of the locating position of the workpiece W is received from the user P, the operation terminal 210 transmits the information on the selected locating position to the information processor 141 (Step S113).

The information processor 141 detects the scheduled operation of the robot 110 based on the information on the selected gripping position and the locating position of the workpiece W, and the route associated data (Step S114).

The information processor 141 generates image data indicative of the scheduled operation of the robot 110 (i.e., the moving route of the end effector 112), and transmits it to the operation terminal 210 (Step S115). The information processor 141 also transmits the first attribute information and the second attribute information to the operation terminal 210.

If the end effector 112 is moved along the moving route, the information processor 141 determines whether there is an interference between the robot 110 and the surrounding component(s) (Step S116). If there is an interference (Yes at Step S116), the information processor 141 transmits the information on the interference to the operation terminal 210 (Step S117), and if there is no interference (No at Step S116), it transits to Step S118.

At Step S118, the operation terminal 210 causes the presenter 230 to present the image data indicative of the moving route of the end effector 112. If there is the interference, an interfering part is displayed in the image displayed by the presenter 230.

Next, if there is an input for approving the scheduled operation of the robot 110 (Yes at Step S119), the operation terminal 210 transmits information on the approval to the information processor 141 (Step S122), and then transits to Step S123. If there is an input for not approving (No at Step S119), the operation terminal 210 transits to Step S120.

At Step S120, the user P inputs a command for changing the scheduled operation of the robot 110 into the operation terminal 210, and the operation terminal 210 then transmits this command to the information processor 141. The above-described command includes a command for changing the scheduled operation itself, a command for changing the gripping position, the arrangement of the workpiece W, or both of these, or a command for changing the first attribute information, the second attribute information or both of these, or a combination of two or more thereof.

At Step S121, the information processor 141 detects the new scheduled operation according to the command for changing the scheduled operation of the robot 110. The information processor 141 repeats the processings at and after Step S115 based on the new scheduled operation.

At Step S123, based on the approved scheduled operation and the three-dimensional position of the workpiece W detected at Step S106, the information processor 141 generates the operating command of the robot 110, and transmits it to the robot controller 142.

The robot controller 142 generates the driving command according to the operating command, and operates the robotic arm 111 and the end effector 112 according to the driving command (Step S124). That is, according to the operating command, the robot controller 142 causes the robotic arm 111 and the end effector 112 to grip the workpiece W on the conveyor belt 121, and to transfer the workpiece W to the conveyance vehicle 122A or 122B.

If the command for the completion of the transferring work is received from the operation terminal 210 (Yes at Step S125), the information processor 141 ends the series of processings, and if the above-described command is not received (No at Step S125), it transits to Step S126.

At Step S126, the information processor 141 causes the robotic arm 111 after the transfer of the workpiece W to the conveyance vehicle 122A or 122B to autonomously move the end effector 112 to near the conveyor belt 121, and repeats the processings at and after Step S105.

In the processings from Step S101 to S126, the information processor 141 requests the user P of the operation terminal 210 for a selection of the gripping position of the workpiece W and the locating position at the transfer destination for every timing at which the end effector 112 grips a new workpiece W, and causes the robot 110 to operate according to the selected result of the user P. For the operation of the robot 110 which requires the judgment of the user P as described above, the user P does not need to manually operate the robot 110 directly, but just needs to select a suitable element from candidates of the element for determining the operation. Therefore, regardless of the user's skills of the robot operation, various users can participate in the operation of the robot 110 from various locations.

### (Modifications)

This modification differs from the embodiment in that the robot system includes a learning device 400. Below, for this modification, the difference from the embodiment is mainly described, and explanation of similarities to the embodiment is suitably omitted.

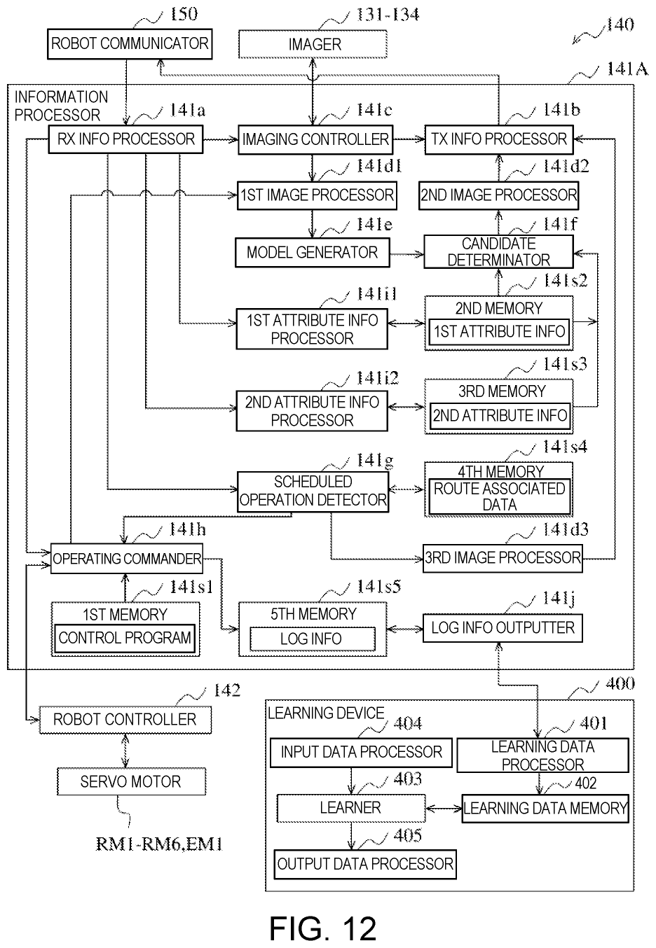

FIG. 12 is a block diagram illustrating one example of a functional configuration of the controller 140 and the learning device 400 according to one modification. As illustrated in FIG. 12, an information processor 141A of the controller 140 further includes a log information outputter 141j as a functional component. The log information outputter 141j outputs the log information stored in the fifth memory 141s5 to a requestor, corresponding to a demand from the outside the information processor 141A. The log information outputter 141j may output the log information to a given output destination at a given timing according to a preset program. The function of the log information outputter 141j is realized by the processor 1411 etc.

The learning device 400 includes a computer similarly to the information processor 141A. For example, the learning device 400 includes circuitry, and this circuitry includes the processor and the memory which are described above. In addition to the memory, the learning device may include the storage described above. The processor of the learning device 400 is one example of a second processor, and the memory and the storage of the learning device 400 are examples of a second storage.

Although not limited, in this modification, the learning device 400 is a separate device from the information processor 141A and the robot controller 142, and is connected with the information processor 141A so that data communications are possible in a wired fashion, a wireless fashion, or a combination thereof. Any kind of wired and wireless communications may be used. The learning device 400 may be incorporated into the information processor 141A or the robot controller 142. The learning device 400 may be connected with the information processor 141A via the communication network N. The learning device 400 may be connected with information processors 141A.

The learning device 400 may be configured to input and output data with the information processor 141A via a storage medium. The storage medium may include a semiconductor-based or other integrated circuits (ICs), a hard disk drive (HDD), a hybrid hard disk drive (HHD), an optical disk, an optical disk drive (ODD), a magneto-optical disk, an optical magnetism drive, a floppy disk drive (FDD), a magnetic tape, a solid drive (SSD), a RAM drive, a secure digital card or drive, other arbitrary suitable storage media, or a combination of two or more thereof.

Although in this modification the learning device 400 is disposed within the robot area AR, it is not limited to this configuration. For example, the learning device 400 may be disposed in the user area AU, or may be disposed at a location different from the robot area AR and the user area AU. For example, the learning device 400 may be disposed at the location where the server 310 is disposed, and may be configured to carry out data communications with the information processor 141A via the server 310. The learning device 400 may be incorporated into the server 310.

The learning device 400 includes a learning data processor 401, a learning data memory 402, a learner 403, an input data processor 404, and an output data processor 405, as functional components. The function of the learning data memory 402 is realized by a memory, a storage, or a combination thereof, which may be included in the learning device 400, and the functions of the functional components other than the learning data memory 402 are realized by the processor etc. which is included in the learning device 400.

The learning data memory 402 stores various information, data, etc., and enables read-out of the stored information, data, etc. For example, the learning data memory 402 stores learning data.

The learning data processor 401 receives the log information from the log information outputter 141j of the information processor 141A, and stores the log information in the learning data memory 402 as learning data. The learning data processor 401 may request the log information outputter 141j for the log information and acquire the log information from the log information outputter 141j, or may acquire the log information sent from the log information outputter 141j at a given timing. For example, the learning data processor 401 may acquire, among the log information, the state information on the workpiece, the first attribute information and the second attribute information corresponding to the state indicated by the state information, and the information on the selected work position, such as the selected gripping position and the selected locating position, which have actually been applied to the workpiece. The above-described selected work position is a work position selected from the candidates of the work position based on the state information, and is an actually-used work position.

The learner 403 includes a learning model, and, in this modification, it includes a learning model for performing machine learning. The learner 403 uses the learning data and causes the learning model to learn to improve the accuracy of output data of the learning model with respect to the input data. The learning model may include a neural network, a Random Forest, Genetic Programming, a regression model, a tree model, a Bayesian model, a time-series model, a clustering model, an ensemble learning model, etc. In this modification, it includes the neural network. The neural network includes node layers including an input layer and an output layer. The node layer includes one or more nodes. When the neural network includes an input layer, middle or hidden layer(s), and an output layer, the neural network sequentially performs output processing from the input layer to the middle layer(s), and output processing from the middle layer(s) to the output layer, and outputs an output result which suits the input information, for information inputted into the node of the input layer. Each node in one layer is connected to respective nodes of the subsequent layer, and a weight is assigned to a connection between the nodes. The weighting of the connection between the nodes is given to the information on the node of one layer and is outputted to a node of the subsequent layer.

The learning model uses the state information on the workpiece as the input data, and uses a reliability of each candidate of the work position for the workpiece corresponding to the state indicated by the state information, as the output data. For example, the learning model may use the state information on the workpiece, and the first attribute information and the second attribute information corresponding to the state indicated by the state information, as the input data. The reliability may be a probability of a correct answer (for example, it may be expressed by a score, a point, etc.).

Further, the learning model uses the state information on the workpiece included in the learning data as learning input data, and uses the information on the selected work position which has actually been applied to the workpiece, as teaching data. For example, the learning model may use the state information on the workpiece, and the first attribute information and the second attribute information corresponding to the state indicated by the state information, which are included in the learning data, as the input data. For example, in the machine learning, the learner 403 adjusts the weighting of the connection between the nodes in the neural network so that, between the reliability of each candidate of the work position which is outputted from the learning model when the input data is inputted, and the selected work position of the teaching data, the reliability matches with the selected work position, or an error or difference is minimized. The learning model after such a weighting adjustment can output the reliability of each candidate of the work position corresponding to the state indicated by the state information with high accuracy, when the state information on the workpiece is inputted.

The input data processor 404 accepts information for inputting into the learning model of the learner 403 from the outside, converts the information into state information which can be inputted into the learning model, and outputs it to the learner 403. For example, the input data processor 404 may accept the information on the workpiece, the first attribute information, and the second attribute information. For example, the information on the workpiece may include information like the imaginary model generated by the model generator 141e of the information processor 141A, information like the data image-processed by the first image processor 141d1, image data like the captured image data of the imagers 131 and 132, a detection result of a sensor which detects the state of the workpiece from outside or inside, or a combination of two or more thereof. The input data processor 404 may convert such information on the workpiece into information indicative of the state of the workpiece and the component(s) of the peripheral environment, such as the positions and the postures of the workpiece and the component(s) of the peripheral environment. The input data processor 404 may accept the information from any kind of device which is capable of outputting the information on the workpiece.

The output data processor 405 determines an optimal work position, based on the reliability of each candidate of the work position for the workpiece, which is outputted from the learner 403, and outputs the information on the optimal work position. For example, the output data processor 405 may output the information to a device relevant to the control of the robot. For example, the output data processor 405 may output the information to a device having the function(s) like the scheduled operation detector 141g or the operating commander 141h of the information processor 141A, or a combination thereof, or may output it to a device like the robot controller 142.

The output data processor 405 may be configured to determine a work position with the highest reliability as the optimal work position, among the candidates of the work position of the workpiece. In this case, the work position with the highest reliability is any one of the candidates of the work position. For example, in the case of the workpiece WA, the work position with the highest reliability is any one of the gripping positions GP1-GP8 illustrated in FIG. 5.

Alternatively, the output data processor 405 may be configured to determine the optimal work position based on an arbitrary position of the workpiece. For example, the output data processor 405 may make a function of a relationship between the work position and its reliability based on information on the candidates of the work position and the respective reliabilities, and calculate the work position with the highest reliability using the function. In this case, the work position with the highest reliability is not limited to the candidates of the work position. For example, in the case of the workpiece WA, the work position with the highest reliability is determined as an arbitrary position on the workpiece WA, which may be a position on the workpiece WA other than the gripping positions GP1-GP8 illustrated in FIG. 5 (for example, a position between the gripping positions GP1 and GP8).

The learning device 400 described above can learn the judgment results of the user P for the operation of the robot 110 which requires the judgment of the user P, and output the optimal judgment result for the operation of the robot 110, instead of the user P. The learning device 400 can learn various judgment results of the user P even from the log information on one information processor 141A of one robot area AR. The learning device 400 can learn various judgment results from the log information on various information processors 141A of various robot areas AR. When the log information is accumulated in the server 310, the learning device 400 can learn various judgment results from the log information on the server 310. Such a learning device 400 can improve the output data to high accuracy.

In this modification, the learning model of the learner 403 may include the function of the output data processor 405, and may be configured to output output data similar to the output data processor 405.

### OTHER EMBODIMENTS

Although examples of the embodiment of the present disclosure are described above, the present disclosure is not limited to the above-described embodiment and the modification. That is, various modifications and improvements are possible within the scope of the present disclosure. For example, forms obtained by applying various modifications to the embodiment and the modification, and forms built by combining the components in different embodiments and modifications are also encompassed in the scope of the present disclosure.

For example, although in the embodiment and the modification the work of the robot 110 which is the target of the robot system 1 is the work for gripping and transferring the workpiece W, it is not limited to this work. The robot system 1 may target any kind of works. For example, the robot system 1 may target works, such as attachment of a workpiece to an object, and assembly, welding, grinding, painting, sealing, etc. of a workpiece. In the case of the work described above, the first attribute information may be the first attribute information on the workpiece, a welding target part, a grinding target part, a painting target part, a sealing target part, etc., for example. The work position of the workpiece may be positions on the workpiece, the welding target part, the grinding target part, the painting target part, the sealing target part, etc., for example. For example, the second attribute information may be the second attribute information on an object to which the workpiece is to be attached, other components to be assembled together with the workpiece, a welding target object, a grinding target object, a painting target object, a sealing target object, etc. The work position of the workpiece may be the position of the workpiece with respect to the attaching target object, the position of the workpiece with respect to other components, the position of the welding target part on the welding target object, the position of the grinding target part on the grinding target object, the position of the painting target part on the painting target object, the position of the sealing target part on the sealing target object, etc., for example.

In this embodiment, the controller 140 is configured to transmit to the operation terminal 210 the candidates of the gripping position of the workpiece W and the candidates of the locating position of the workpiece W in the conveyance vehicle 122A or 122B, and request a selection by the user P. The elements for which the controller 140 requests the selection are not limited to these, as long as they are elements which are selectable by a judgment of the user P. For example, the controller 140 may be configured to transmit to the operation terminal 210 the candidates of the posture of the workpiece W, the gripping force to the workpiece W, etc. in each operation of the robot 110, and request the selection by the user P.

In the embodiment and the modification, the controller 140 is configured not to directly control the drive of the motor of the conveyor belt 121, but it may be configured to control directly as an external axis control. Therefore, the controller 140 can control the operation of the robot 110 and the operation of the conveyor belt 121 so that they collaborate with high precision.

In the embodiment and the modification, the controller 140 is configured, in order to detect the state information on the workpiece W, to use the image data captured by the imager 131 to perform the image processings for the extraction of the workpiece W, the detection of the three-dimensional position of the workpiece W, etc., but it is not limited to this configuration. The image data used for the above-described image processings may be any image data, as long as it is image data of an imager which is capable of capturing the workpiece W. For example, image data captured by the imager 132 which images the workpiece W from above may be used. In this case, before the robotic arm 111 returns the end effector 112 near the conveyor belt 121 after the transfer of the workpiece W, the controller 140 is able to carry out the image processing of the image data of the imager 132. Therefore, a prompt work becomes possible.

In the embodiment and the modification, the controller 140 is configured to use the image data obtained by capturing the workpiece W in order to acquire the state information on the workpiece W, but it is not limited to this configuration. For example, the controller 140 may be configured to acquire the state information on the workpiece W based on a detection result of an external sensor which is a sensor disposed separately from the workpiece W, a detection result of a loading sensor which is a sensor disposed at the workpiece W, or a combination thereof. The external sensor may detect the position, the posture, etc. of the workpiece W from the outside of the workpiece W. For example, the external sensor may detect the workpiece W using light wave, laser, magnetism, radio wave, electromagnetic wave, ultrasonic wave, or a combination of two or more thereof, and it may be a photoelectric sensor, a laser sensor, a radio wave sensor, an electromagnetic wave sensor, an ultrasonic sensor, various LiDARs, or a combination of two or more thereof. The loading sensor may move along with the workpiece W, and detect the position, the posture, etc. of the workpiece W. For example, the loading sensor may be an acceleration sensor, an angular velocity sensor, a magnetic sensor, a GPS (Global Positioning System) receiver, or a combination of two or more thereof.

The information processor 141 according to one embodiment may be configured to use an AI (Artificial Intelligence) for processing. For example, the AI can be used for the image processing of the image data captured by the imagers 131 and 132, the processing for generating the imaginary model based on the information on the workpiece W extracted from the image data, the processing for determining the candidates of the work position for the workpiece W based on the attribute information and the imaginary model, etc.

For example, the AI may include a learning model for performing machine learning. For example, the learning model may include a neural network. For example, the learning model for performing the image processing may use the image data as input data, and use information on an edge or a three-dimensional position of a photographic subject projected to the image data, or a combination thereof, as output data. The learning model for generating the imaginary model may use information on the edge or the three-dimensional position of the photographic subject extracted from the image data, or a combination thereof, as input data, and use information on the imaginary model of the photographic subject as output data. The learning model for determining the candidates of the work position for the workpiece W may use information on the imaginary models of the workpiece W and the surrounding component(s) as input data, and use the candidates of the work position, such as the gripping position of the workpiece W, as output data. The learning model may be a model for carrying out machine learning using learning data corresponding to the input data, and teaching data corresponding to the output data.

In the embodiment and the modification, the server 310 is configured to connect one selected from the operation terminals 210 with one robot group which is a combination of the robot 110 and its controller 140, but it is not limited to this configuration. The server 310 may be configured to connect one selected from the operation terminals 210 with one selected from robot groups.

Each example of the aspect of the art of the present disclosure is given as follows. The controller according to one aspect of the present disclosure is a controller that performs a control in which a robot autonomously performs a given work. The controller includes a first processor. The first processor performs processing including acquiring state information including a state of a workpiece which is a work target while performing the given work, determining candidates of a work position of the workpiece based on the state information, transmitting a selection request for requesting a selection of the work position from the candidates of the work position to an operation terminal, the operation terminal being connected data-communicably with the first processor via a communication network, and when information on a selected position that is the selected work position is received from the operation terminal, causing the robot to operate autonomously according to the selected position.

According to the above-described aspect, the user of the operation terminal does not directly manipulate the robot for manual operation, but indirectly manipulates the robot for autonomous operation according to the command of the selected position, by using the operation terminal. The user is not required to have operation skill for direct manipulation, and can cause the robot to operate as he/she intends, by simple operation. For example, if there is an operation of the robot in which a judgment by a person is useful, the controller can cause the robot to perform suitable operation by following the selected position which is determined by the user, without being influenced by the skill level of the user. Since skill of direct manipulation is not required for the user, various users can participate in manipulation of the robot. The operation terminal may be any operation terminal, as long as it enables the selection of the selected position by the user and the transmission of the information on the selected position to the controller. Thus, the operation terminal is not limited to operation terminals for exclusive use for robots, but various terminals are applicable. Further, since the amount of data communicated between the operation terminal and the controller is reduced, rapid and certain communications are possible using various communication networks. Therefore, the controller can connect with various operation terminals of various users at various locations by communication via the communication network so that the robot operates according to the users' operation. Thus, manipulation of the operation of the robot which requires a judgment by the operator is automated, which enables diversification of available operators.

In the controller according to one aspect of the present disclosure, in the processing of acquiring the state information, the first processor may acquire first image data that is data of an image obtained by capturing the workpiece, and detect the state information by carrying out image processing of the first image data. According to the above-described aspect, the controller can perform by itself the processings from the detection of the state information on the workpiece to the determination of the candidates of the work position.

In the controller according to one aspect of the present disclosure, in the processing of transmitting the selection request to the operation terminal, the first processor may acquire first image data that is data of an image obtained by capturing the workpiece and carry out image processing of the first image data to generate second image data that is data of an image indicating candidates of the work position on the image of the first image data, and the first processor may transmit the selection request using the second image data to the operation terminal. According to the above-described aspect, the controller can request for the selection of the selected position using the image indicating the candidates of the work position on the captured image of the workpiece.

In the controller according to one aspect of the present disclosure, the first processor may further perform processing including, when the information on the selected position is received from the operation terminal, detecting a scheduled operation of the robot according to the selected position, and transmitting information on the scheduled operation to the operation terminal to cause the operation terminal to present the information. According to the above-described aspect, the controller can present to the user the scheduled operation of the robot according to the selected position. For example, the controller may cause the robot to perform the scheduled operation after the scheduled operation is approved by the user.

In the controller according to one aspect of the present disclosure, the first processor may accept a change in the scheduled operation through the operation terminal, and cause the robot to operate autonomously according to the changed scheduled operation. According to the above-described aspect, the user can change the scheduled operation presented to the operation terminal so that the robot performs the changed scheduled operation. For example, if the user confirms that the robot interferes with an object around the robot in the scheduled operation, the user can change the scheduled operation to avoid the interference, by using the operation terminal. In this case, the user may change the selected position, or may change the route of the operation of the robot in the scheduled operation, for example. It enables certain and safe operation of the robot.

The controller according to one aspect of the present disclosure may further include a first storage. The first storage may store first attribute information including information on characteristics of the workpiece and the given work set to the workpiece. The first processor may cause the robot to operate autonomously according to the first attribute information and the selected position.

According to the above-described aspect, the controller can cause the robot to perform operation suitable for the workpiece. For example, when the first attribute information includes the characteristics of the workpiece, such as the elasticity, the plasticity, the toughness, the brittleness, the expansibility, etc., the controller can determine the gripping force in the operation of gripping the workpiece by the robot based on the first attribute information. When the first attribute information includes the information on the given work, such as the moving posture and the moving speed of the workpiece, the controller can determine the posture and the moving speed of the workpiece in the operation of moving the workpiece by the robot, based on the first attribute information.

In the controller according to one aspect of the present disclosure, the first processor may further perform processing including transmitting the first attribute information corresponding to the selected position to the operation terminal to cause the operation terminal to present the first attribute information. The first processor may accept a change in the first attribute information through the operation terminal, and change the first attribute information according to the accepted change. The first processor may cause the robot to operate autonomously according to the changed first attribute information and the selected position. According to the above-described aspect, the controller can determine the operation of the robot based on the first attribute information according to the judgment of the user of the operation terminal. The controller can reflect the judgment result of the user, other than the selected position, on the control of the operation of the robot.

In the controller according to one aspect of the present disclosure, the first attribute information may include information on a position at which the robot is applicable of an action to the workpiece. In the processing of determining the candidates of the work position, the first circuit may determine candidates of a position at which the robot applies the action to the workpiece based on the first attribute information, as the candidates of the work position. According to the above-described aspect, the controller stores the information on the candidates of an action position set to the workpiece as the first attribute information. Therefore, the controller can reduce an amount of processing for determining the candidates of the work position.

The controller according to one aspect of the present disclosure may further include a first storage. The first storage may store second attribute information including information on characteristics of a peripheral environment of the workpiece and the given work set to the peripheral environment. The first processor may cause the robot to operate autonomously according to the second attribute information and the selected position.

According to the above-described aspect, the controller can cause the robot to perform an operation suitable for the peripheral environment. For example, when the second attribute information includes the characteristics of the peripheral environment, such as the elasticity, the plasticity, the toughness, the brittleness, the expansibility, etc. of the surface where the workpiece is to be located at the transfer destination of the workpiece, which is the peripheral environment, the controller can determine the speed and the acceleration of the workpiece in the operation of locating the workpiece on the locating surface by the robot, based on the second attribute information. When the second attribute information includes the information on the given work, such as the arrangement order, arrangement direction, etc. for locating positions at the transfer destination of the workpiece, the controller can determine the arrangement order and the arrangement direction of the workpiece in the operation of locating the workpiece by the robot, based on the second attribute information.

In the controller according to one aspect of the present disclosure, the first processor may further perform processing including transmitting the second attribute information corresponding to the selected position to the operation terminal to cause the operation terminal to present the second attribute information. The first processor may accept a change in the second attribute information through the operation terminal, and change the second attribute information according to the accepted change. The first processor may cause the robot to operate autonomously according to the changed second attribute information and the selected position. According to the above-described aspect, the controller can determine the operation of the robot based on the second attribute information according to the judgment of the user of the operation terminal. The controller can reflect the judgment result of the user, other than the selected position, on the control of the operation of the robot.

In the controller according to one aspect of the present disclosure, the second attribute information may include information on a position of the workpiece with respect to the peripheral environment. In the processing of determining the candidates of the work position, the first processor may determine candidates of the position of the workpiece with respect to the peripheral environment based on the second attribute information, as the candidates of the work position. According to the above-described aspect, the controller stores the information on the candidates of the position of the workpiece with respect to the peripheral environment set to the peripheral environment as the second attribute information. Therefore, the controller can reduce the amount of processing for determining the candidates of the work position.

The robot system according to one aspect of the present disclosure includes the controller according to one aspect of the present disclosure and the robot controlled by the controller. According to the above-described aspect, similar effects to the controller according to one aspect of the present disclosure are achieved.

The robot system according to one aspect of the present disclosure may further include robot groups including combinations of the controller and the robot controlled by the controller, and a mediator data-communicably connected to the communication network, the mediator mediating a connection between the operation terminal selected from the operation terminals, and the controller of the robot group selected from the robot groups.

According to the above-described aspect, any user among the users of the operation terminals can cause the robot of any robot group among the robot groups to perform operation according to the selected position. For example, the users can indirectly manipulate the robots of one robot group while taking turns. Thus, the robot can operate continuously, while the operating burden of each user is reduced. For example, the robot can be indirectly manipulated by a user suitable for the robot and the given work, among the users.

The learning device according to one aspect of the present disclosure includes a second processor and a second storage. The second storage stores the state information and the selected position corresponding to the state information that are acquired by one or more controllers according to one aspect of the present disclosure, as learning data. The selected position corresponding to the state information is the selected position selected from the candidates of the work position based on the state information. The second processor performs processing including learning, while using the state information on the learning data as learning input data, and the information on the selected position of the learning data corresponding to the state information as teaching data, and accepting input state information that is the state information including the state of the workpiece as input data, and outputting information on an optimal work position among the candidates of the work position of the workpiece corresponding to the input state information as output data.

According to the above-described aspect, the learning device can learn the selection result of the work position by the user of the operation terminal (i.e., the judgment result of the user). The learning device after the learning can determine and output an optimal position for the work position among the candidates of the work position, instead of the user of the operation terminal. Therefore, the learning device can further automate the manipulation of the operation of the robot which requires the judgment of the user. The second processor and the second storage may be provided separately from or integrally with the first processor and the first storage, respectively.

The learning device according to one aspect of the present disclosure includes a second processor and a second storage. The second storage stores the state information and the selected position corresponding to the state information that are acquired by one or more controllers according to one aspect of the present disclosure, as learning data. The selected position corresponding to the state information is the selected position selected from the candidates of the work position based on the state information. The second processor performs processing including learning, while using the state information on the learning data as learning input data, and the information on the selected position of the learning data corresponding to the state information as teaching data, accepting input state information that is the state information including the state of the workpiece as input data, and outputting a reliability of the candidate of the work position of the workpiece corresponding to the input state information as output data, and based on the reliability, determining an optimal work position from arbitrary positions of the workpiece, and outputting information on the optimal work position.

According to the above-described aspect, the learning device can learn the selection result of the work position by the user of the operation terminal (i.e., the judgment result of the user). The learning device after the learning can determine and output the optimal work position among arbitrary positions, instead of the user of the operation terminal. Therefore, the learning device can further automate the manipulation of the operation of the robot which requires the judgment of the user. The second processor and the second storage may be provided separately from or integrally with the first processor and the first storage, respectively.

The functions of the elements disclosed herein can be performed using circuitry or processing circuitry including a general-purpose processor, a dedicated processor, an integrated circuit, an ASIC (Application-Specific Integrated Circuit), conventional circuitry, and/or a combination thereof, which are configured or programmed to execute the disclosed functions. Since the processor includes transistors or other circuitry, it is considered to be the processing circuitry or the circuitry. In this disclosure, the circuitry, the unit, or the means is hardware which performs the listed functions, or is hardware programmed to perform the listed functions. The hardware may be hardware disclosed herein, or may be other known hardware which are programmed or configured to perform the listed functions. When the hardware is the processor considered to be a kind of circuitry, the circuitry, the means, or the unit is a combination of hardware and software, and the software is used for a configuration of the hardware and/or the processor.

All the numbers used above, such as the order and the quantity, are illustrated in order to concretely explain the technique of the present disclosure, and the present disclosure is not limited to the illustrated numbers. The connection relationships between the components are illustrated in order to concretely explain the technique of the present disclosure, and the connection relationship which realizes the functions of the present disclosure is not limited to those relationships.

The division of a block in the functional block diagram is one example. Blocks may be realized as one block, one block may be divided into blocks, and a part of a function may be moved to other blocks, and the blocks may be combined. Functions of blocks which have similar functions may be processed in parallel or in a time-divided manner by sole hardware or software.

Since the scope of the present disclosure is defined by the appended claims rather than the description of this specification so that the present disclosure may be implemented in various ways without departing from the spirit of the essential features, the illustrative embodiment and modifications are illustrative but not restrictive. All the modifications of the claims and all the modifications within the scope of the claims, or the equivalents of the claims and the equivalents within the scope of the claims are intended to be encompassed in the appended claims.

1. A controller that performs a control in which a robot autonomously performs a given work, the controller comprising:
a first processor, the first processor performs processing including:
acquiring state information including a state of a workpiece that is a work target while performing the given work;
determining candidates of a work position of the workpiece based on the state information;
transmitting a selection request for requesting a selection of the work position from the candidates of the work position to an operation terminal, the operation terminal being connected data-communicably with the first processor via a communication network; and
when information on a selected position that is the selected work position is received from the operation terminal, causing the robot to operate autonomously according to the selected position.

2. The controller of claim 1, wherein, in the processing of acquiring the state information, the first processor acquires first image data that is data of an image obtained by capturing the workpiece, and detects the state information by carrying out image processing of the first image data.

3. The controller of claim 1, wherein, in the processing of transmitting the selection request to the operation terminal, the first processor acquires first image data that is data of an image obtained by capturing the workpiece and carries out image processing of the first image data to generate second image data that is data of an image indicating candidates of the work position on the image of the first image data, and the first processor transmits the selection request using the second image data to the operation terminal.

4. The controller of claim 1, wherein the first processor further performs processing including:
when the information on the selected position is received from the operation terminal, detecting a scheduled operation of the robot according to the selected position; and
transmitting information on the scheduled operation to the operation terminal to cause the operation terminal to present the information.

5. The controller of claim 4, wherein the first processor accepts a change in the scheduled operation through the operation terminal, and causes the robot to operate autonomously according to the changed scheduled operation.

6. The controller of claim 1, further comprising a first storage,
wherein the first storage stores first attribute information including information on characteristics of the workpiece and the given work set to the workpiece, and
wherein the first processor causes the robot to operate autonomously according to the first attribute information and the selected position.

7. The controller of claim 6, wherein the first processor further performs processing including transmitting the first attribute information corresponding to the selected position to the operation terminal to cause the operation terminal to present the first attribute information,
wherein the first processor accepts a change in the first attribute information through the operation terminal, and changes the first attribute information according to the accepted change, and
wherein the first processor causes the robot to operate autonomously according to the changed first attribute information and the selected position.

8. The controller of claim 6, wherein the first attribute information includes information on a position at which the robot is applicable of an action to the workpiece, and
wherein, in the processing of determining the candidates of the work position, the first processor determines candidates of a position at which the robot applies the action to the workpiece based on the first attribute information, as the candidates of the work position.

9. The controller of claim 1, further comprising a first storage,
wherein the first storage stores second attribute information including information on characteristics of a peripheral environment of the workpiece and the given work set to the peripheral environment, and
wherein the first processor causes the robot to operate autonomously according to the second attribute information and the selected position.

10. The controller of claim 9, wherein the first processor further performs processing including transmitting the second attribute information corresponding to the selected position to the operation terminal to cause the operation terminal to present the second attribute information,
wherein the first processor accepts a change in the second attribute information through the operation terminal, and changes the second attribute information according to the accepted change, and
wherein the first processor causes the robot to operate autonomously according to the changed second attribute information and the selected position.

11. The controller of claim 9, wherein the second attribute information includes information on a position of the workpiece with respect to the peripheral environment, and
wherein, in the processing of determining the candidates of the work position, the first processor determines candidates of the position of the workpiece with respect to the peripheral environment based on the second attribute information, as the candidates of the work position.

12. A robot system, comprising:
the controller of claim 1; and
the robot controlled by the controller.

13. The robot system of claim 12, further comprising:
robot groups including combinations of the controller and the robot controlled by the controller; and
a mediator data-communicably connected to the communication network, the mediator mediating a connection between the operation terminal selected from the operation terminals, and the controller of the robot group selected from the robot groups.

14. A learning device, comprising:
a second processor; and
a second storage,
wherein the second storage stores the state information and the selected position corresponding to the state information that are acquired by one or more controllers of claim 1, as learning data,
wherein the selected position corresponding to the state information is the selected position selected from the candidates of the work position based on the state information, and
wherein the second processor performs processing including:
learning, while using the state information on the learning data as learning input data, and the information on the selected position of the learning data corresponding to the state information as teaching data; and
accepting input state information that is the state information including the state of the workpiece as input data, and outputting information on an optimal work position among the candidates of the work position of the workpiece corresponding to the input state information as output data.

15. A learning device, comprising:
a second processor; and
a second storage,
wherein the second storage stores the state information and the selected position corresponding to the state information that are acquired by one or more controllers of claim 1, as learning data,
wherein the selected position corresponding to the state information is the selected position selected from the candidates of the work position based on the state information, and
wherein the second processor performs processing including:
learning, while using the state information on the learning data as learning input data, and the information on the selected position of the learning data corresponding to the state information as teaching data;
accepting input state information that is the state information including the state of the workpiece as input data, and outputting a reliability of the candidate of the work position of the workpiece corresponding to the input state information as output data; and
based on the reliability, determining an optimal work position from arbitrary positions of the workpiece, and outputting information on the optimal work position.
